(19) United States
(12) Patent Application Publication
(10) Pub. No.: US 2009/0154344 A1
(43) Pub. Date: Jun. 18, 2009

(54) WIRELESS COMMUNICATION SYSTEM, COMMUNICATION TERMINAL AND STORAGE MEDIUM STORING WIRELESS COMMUNICATION PROGRAM

(75) Inventor: Makoto Nishida, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/394,967

(22) Filed: Feb. 27, 2009

Related U.S. Application Data
(63) Continuation-in-part of application No. PCT/JP2007/065162, filed on Aug. 2, 2007.

(30) Foreign Application Priority Data
Aug. 31, 2006 (JP) 2006236383

(51) Int. Cl. H04W 84/20; G06F 11/00

(52) U.S. Cl. 370/221; 370/328

(57) ABSTRACT

A wireless communication system comprises a control terminal and a controlled terminal, the control terminal comprises a control information transmitter transmitting the control information, a response information receptor receiving response information, a selector selecting the controlled terminal to become a new control terminal, a request information transmitter transmitting request information, and a controlled terminal transition device stopping the control terminal being the control terminal and transfers to become the controlled terminal, and the controlled terminal that operates based on the control information transmitted a control information receptor receiving the control information, a response information transmitter transmitting the response information, an operation execution device performing an operation prescribed by the control information, a request information receptor receiving the request information, an acceptance information transmitter transmitting the acceptance information, and a control terminal transition device stopping the controlled terminal being the controlled terminal and transfers to become the control terminal.

### CROSS-REFERENCE TO RELATED APPLICATION

This application is a U.S. continuation-in-part application filed under 35 USC 111(a) claiming benefit under 35 USC 120 and 365(c) of International Application No. PCT/JP2007/065162 filed Aug. 2, 2007, which claims priority to Application Ser. No. 2006-236383, filed in Japan on Aug. 31, 2006. The disclosure of the foregoing applications is hereby incorporated by reference in their entireties.

### BACKGROUND

1. Field of the Invention

The disclosure relates to a wireless communication system, a communication terminal and a storage medium storing a wireless communication program for communication terminal.

2. Description of Related Art

Generally, in wireless ad hoc communication that is not performed via an access point, when one terminal is communicating with a plurality of terminals, it is conceivable that communication may become impossible for some reason. For example, if the terminal performing the broadcasting (hereinafter referred to as the “control terminal”) malfunctions, it is preferable for another of the terminals to take the place of the terminal performing the broadcasting. A method is disclosed, for example, in Japanese Laid-Open Patent Publication No. 2005-6327, in which an order of priority for the terminals that can become the control terminal (the coordinator terminal) and perform the broadcasting is established in advance. In this method, if a problem occurs in communication using the current coordinator terminal, it is promptly replaced.

However, a cause of failure of communication in wireless ad hoc communication is not limited to the malfunction of the control terminal. For example, environmental causes sometimes occur, such as a reception terminal moving out of communication range, a shield arising between the control terminal and the reception terminal and the like. When failure of one or more of non-control terminals occurs, the control terminal still retains its communication capabilities and continue to use the predetermined order of priority without taking into consideration of the one or more non-control terminals for which communication has failed.

### SUMMARY

To address this, the present disclosure provides a new and improved wireless communication system, communication terminal and storage medium storing a wireless communication program that operate when communication fails due to an environmental cause.

To solve the problem described above, in a first aspect of this disclosure, a wireless communication system that is connected via a wireless network to a control terminal and a controlled terminal, wherein the control terminal and the controlled terminal belong to one or more groups and the control terminal performs transmission to each of the groups, the control terminal that transmits control information includes a control information transmitter that transmits the control information to a plurality of the controlled terminals, a response information receptor that receives response information from the controlled terminal, a selector that selects the controlled terminal from among the controlled terminals to become a new control terminal to replace the current control terminal when the response information receptor has not received the response information from one of the controlled terminals belonging to one of the groups within a prescribed period of time, a request information transmitter that transmits request information to the controlled terminal selected by the selector to request the selected controlled terminal to become the control terminal and a controlled terminal transition device that stops the control terminal being the control terminal and transfers it to become the controlled terminal when acceptance information has been received from the controlled terminal indicating acceptance to become the control terminal, and the controlled terminal that operates based on the control information transmitted from the control terminal includes a control information receptor that receives the control information from the control terminal, a response information transmitter that transmits the response information to the control terminal when the control information is received by the control information receptor, an operation execution device that performs an operation prescribed by the control information received by the control information receptor, a request information receptor that receives the request information from the control terminal, an acceptance information transmitter that transmits the acceptance information to the control terminal when the request information is received by the request information receptor and a control terminal transition device that, when the acceptance information is transmitted by the acceptance information transmitter, stops the controlled terminal being the controlled terminal and transfers it to become the control terminal.

To solve the problems describes above, in a second aspect of this disclosure, a communication terminal that is mutually connected to other communication terminals via a network, wherein when the communication terminal functions as a control terminal that transmits control information, the communication terminal includes a control information transmitter that transmits the control information to a controlled terminal, a response information receptor that receives response information from the controlled terminal, a selector that selects the controlled terminal from among the controlled terminals to become a new control terminal to replace the current control terminal when the response information receptor has not received the response information from one of the controlled terminals belonging to a group within a prescribed period of time, a request information transmitter that transmits request information to the controlled terminal selected by the selector to request the selected controlled terminal to become the control terminal and a controlled terminal transition device that stops the control terminal being the control terminal and transfers it to become the controlled terminal when acceptance information has been received from the controlled terminal indicating acceptance to become the control terminal and wherein when the communication terminal functions as the controlled terminal that operates based on the control information transmitted from the control terminal, the communication terminal includes a control information receptor that receives the control information from the control terminal, a response information transmitter that transmits the response information to the control terminal when the control information is received by the control information receptor, an operation execution device that performs an operation prescribed by the control information received by the control information receptor, a request information receptor that receives the request information from the control terminal, an acceptance information transmitter that transmits the acceptance information to the control terminal when the request information is received by the request information receptor and a control terminal transition device that, when the acceptance information is transmitted by the acceptance information transmitter, stops the controlled terminal being the controlled terminal and transfers it to become the control terminal.

To solve the problems described above, in a third aspect of this disclosure, a computer-readable storage medium storing a wireless communication program that causes a computer to function to perform the variety of processes of the communication terminal described above.

Other objects, features, and advantages will be apparent to persons of ordinary skill in the art from the following detailed description of the invention and the accompanying drawings.

### BRIEF DESCRIPTION OF THE DRAWINGS

For a more complete understanding of the invention, the needs satisfied thereby, and the features and technical advantages thereof, reference now is made to the following descriptions taken in connection with the accompanying drawings.

FIG. 1 is an explanatory diagram showing an outline of a wireless communication system;

FIG. 2 is a block diagram showing an electrical configuration of a leader terminal and a member terminal;

FIG. 3 is a schematic diagram showing a RAM storage area;

FIG. 4 is an explanatory diagram showing transceived data transmitted and received using the wireless communication system according to a first embodiment;

FIG. 5 is a flow chart of a main process of a communication terminal according to the first embodiment;

FIG. 6 is a flow chart of a leader terminal process performed during the main process;

FIG. 7 is a flow chart of a communication status verification process performed during the leader terminal process;

FIG. 8 is a flow chart of a control information transmission process performed during the leader terminal process;

FIG. 9 is a flow chart of a new leader request process performed during the leader terminal process;

FIG. 10 is a flow chart of a member terminal process performed during the main process;

FIG. 11 is an explanatory diagram showing transceived data transmitted and received using the wireless communication system according to a second embodiment;

FIG. 12 is a flow chart of a main process of the communication terminal according to the second embodiment;

FIG. 13 is a flow chart of a timer process activated in the main process;

FIG. 14 is a flow chart of a leader terminal process performed during the main process;

FIG. 15 is a flow chart of a communication status verification process performed during the leader terminal process;

FIG. 16 is a flow chart of a new leader request process performed during the leader terminal process;

FIG. 17 is a flow chart of a data reception/transmission process activated during the leader terminal process;

FIG. 18 is an explanatory diagram showing the transceived data transmitted and received using the wireless communication system according to a third embodiment;

FIG. 19 is a flow chart of a main process of the communication terminal according to the third embodiment;

FIG. 20 is a flow chart of a leader terminal process performed during the main process;

FIG. 21 is a flow chart of a data reception/transmission process activated during the leader terminal process;

FIG. 22 is an explanatory diagram showing the transceived data transmitted and received using the wireless communication system according to a fourth embodiment;

FIG. 23 is a flow chart of a leader terminal process performed during a main process of the communication terminal according to the fourth embodiment;

FIG. 24 is a flow chart of a data collection process performed during the leader terminal process; and

FIG. 25 is a flow chart of a member terminal process performed during the main process of the communication terminal according to the fourth embodiment.

### DETAILED DESCRIPTION OF THE EMBODIMENTS

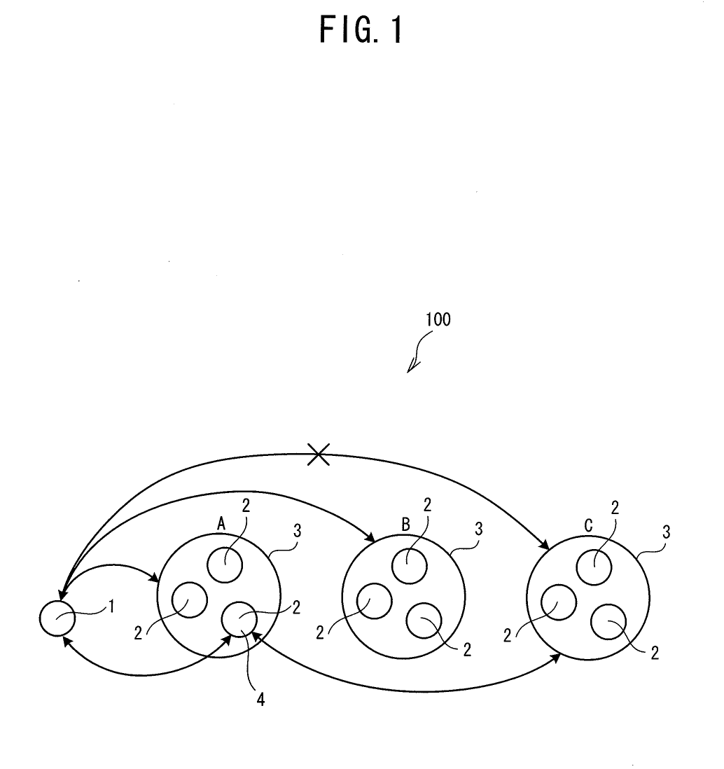

Embodiments of the invention and their features and technical advantages may be understood by referring to FIGS. 1-25, like numerals being used for like corresponding parts in the various drawings.

Hereinafter, a wireless communication system 100 according to embodiments of the present disclosure will be explained with reference to the figures. First, an outline of the wireless communication system 100 will be explained with reference to FIG. 1.

In the wireless communication system shown in FIG. 1, a plurality of wireless communication terminals (hereinafter also referred to as “communication terminals” or “terminals”) perform ad hoc communication. Each of the wireless communication terminals has the same physical structure (to be explained in detail later), and each of the wireless communication terminals functions either as a control terminal (hereinafter referred to as the “leader terminal”) that transmits control information to the other terminals, or as a controlled terminal (hereinafter referred to as the “member terminal”) that receives the control information and performs a prescribed operation in accordance with the control information. There is a plurality of groups 3 in the wireless communication system 100 (group A, group B and group C in FIG. 1), and each of the member terminals 2 belongs to one of the groups 3. The leader terminal 1 performs synchronous communication group by group with each of the groups 3.

If the synchronous communication from the leader terminal 1 to the group C fails, the leader terminal 1 requests one of the member terminals 2 to become the leader terminal in its place. The member terminal 2 receiving the request becomes a new leader terminal 4, and from that point, the new leader terminal 4 performs communication as the leader terminal 1 and the previous leader terminal 1 becomes the member terminal 2.

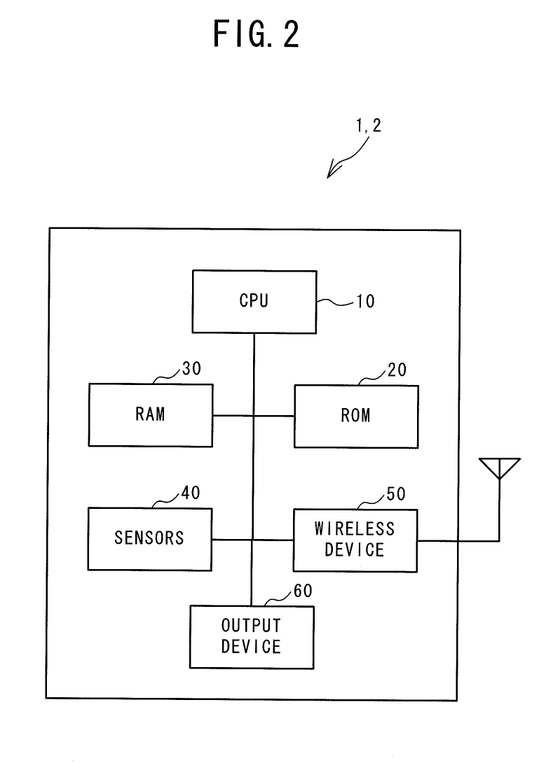

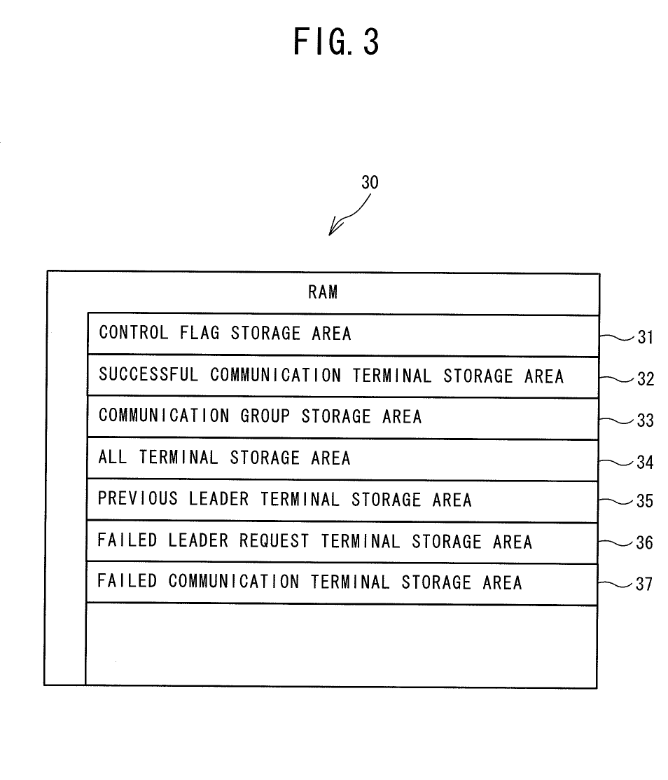

Next, an electrical configuration of the communication terminals (the leader terminal 1 and the member terminal 2) that form the wireless communication system 100 will be explained with reference to FIG. 2 and FIG. 3.

As shown in FIG. 2, the leader terminal 1 and the member terminal 2 include a CPU 10 that controls the overall functions of the communication terminal, a ROM 20 that stores programs etc. and a RAM 30 that temporarily stores data. The ROM 20 and the RAM 30 are connected via a bus to the CPU 10. The leader terminal 1 and the member terminal 2 include a variety of sensors 40 and an output device 60. A temperature sensor, an infrared sensor, a light sensor, a microphone and the like are used, for example, in the sensors 40. An LED, a motor and speakers and the like, are used, for example, in the output device 60. The leader terminal 1 and the member terminal 2 include a wireless device 50 for communication with other terminals.

As shown in FIG. 3, storage areas are established in the RAM 30, such as a control flag storage area 31, a successful communication terminal storage area 32, a communication group storage area 33, an all terminal storage area 34, a previous leader terminal storage area 35, a failed leader request terminal storage area 36 and a failed communication terminal storage area 37. The control flag storage area 31 stores a control flag that indicates whether the terminal is functioning as the leader terminal 1. The successful communication terminal storage area 32 stores a list of the terminals that returned a response when the leader terminal 1 transmitted a communication status check to the member terminals 2 in each of the groups 3 (a successful communication terminal list). The communication group storage area 33 stores an order of the communication groups (a communication group list). The all terminal storage area 34 stores the ID of all the terminals (an all terminal list). The previous leader terminal storage area 35 stores a list of the terminals that have functioned as the leader terminal 1 (a previous leader terminal list). The failed leader request terminal storage area 36 stores a list of the terminals that did not return a response to a request to become the leader terminal 1 (a failed leader request terminal list). The failed communication terminal storage area 37 stores a list of the terminals that, from among all the terminals, are not on the successful communication terminal list (a failed communication terminal list).

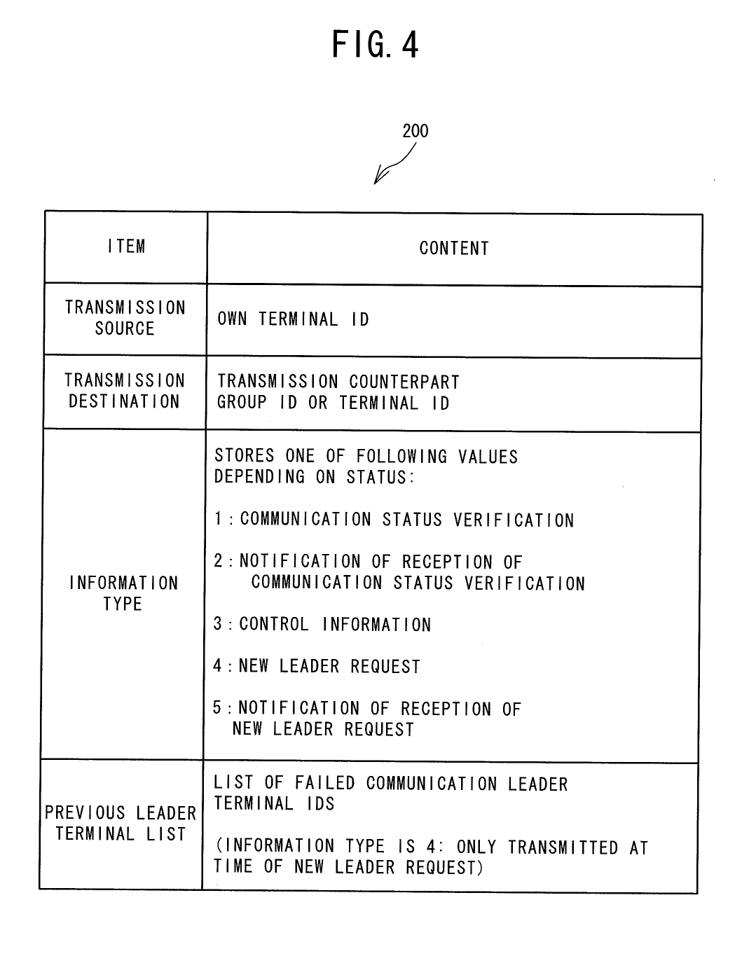

The operation of the wireless communication system 100 according to a first embodiment will be explained with reference to FIG. 4 to FIG. 10.

In the wireless communication system 100 according to the first embodiment, transceived data 200 is transmitted and received as shown in FIG. 4. As shown in FIG. 4, the transceived data 200 includes four items, namely transmission source information, transmission destination information, information type and the previous leader terminal list. The ID of the terminal transmitting the relevant data is set in the transmission source information. The ID of the transmission counterpart group or the ID of the transmission counterpart terminal is set in the transmission destination information. As broadcast transmission is performed in the wireless communication system 100, the transmission counterpart ID is essential. When the ID set in the transmission destination information of the received data matches the terminal's own ID, or matches the ID of the group to which the terminal belongs, each of the terminals determines that the data is targeted to itself. One of a value from 1 to 5 is set in the information type. Each of the values is allocated to the following type of functions. 1: Communication status verification; 2: Notification of reception of communication status verification; 3: Control information; 4: New leader request; 5: Notification of reception of new leader request. When the information type is “4”, the previous leader terminal list, that is the list of the terminals that have previously been the leader terminal, is attached.

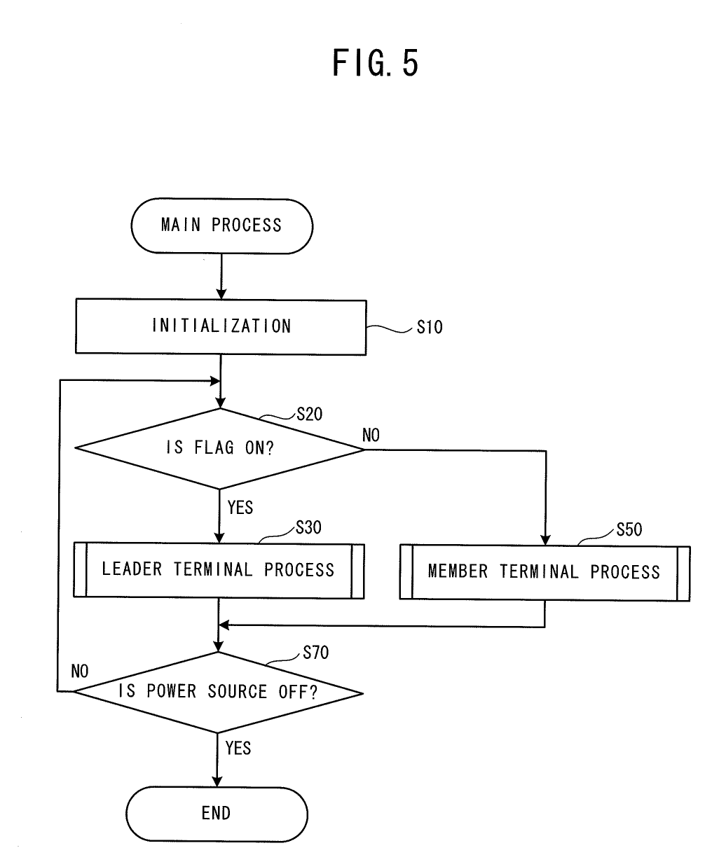

In the first embodiment, the communication terminal repeatedly performs a main process, as shown in FIG. 5, from when the power source is turned on until the power source is turned off. During the main process, if the communication terminal is the current leader terminal 1, the communication terminal performs processing as the leader terminal. On the other hand, if the communication terminal is the member terminal 2, the communication terminal performs processing as the member terminal.

As shown in FIG. 5, when the power source of the communication terminal is turned on, the main process is started. First, the communication terminal performs an initialization process, including clearing certain content of the communication terminal RAM 30 and so on (step S10). It is then determined whether “1” is stored in the control flag storage area 31, namely whether the control flag (control_flg) is “ON” (step S20). If the control flag is “ON”, the communication terminal functions as the leader terminal. “1” is stored in the control flag storage area 31 of the initial leader terminal 1 as a default value. Each time the leader terminal 1 is replaced, the control flag of the previous leader terminal 1 is turned “OFF” and the control flag of the new leader terminal is switched “ON” (this will be explained in more detail later).

Accordingly, when the control flag is “ON” (yes at step S20), a leader terminal process is performed (step S30). On the other hand, if the control flag is “OFF” (no at step S20), a member terminal process is performed (step S50).

When the leader terminal process and the member terminal process end, it is determined whether the communication terminal power source is “OFF” (step S70). If the power source has been switched “OFF” (yes at step S70), all processes are ended. On the other hand, if the power source has not been switched “OFF” (no at step S70), the process returns to step S20 and is repeated.

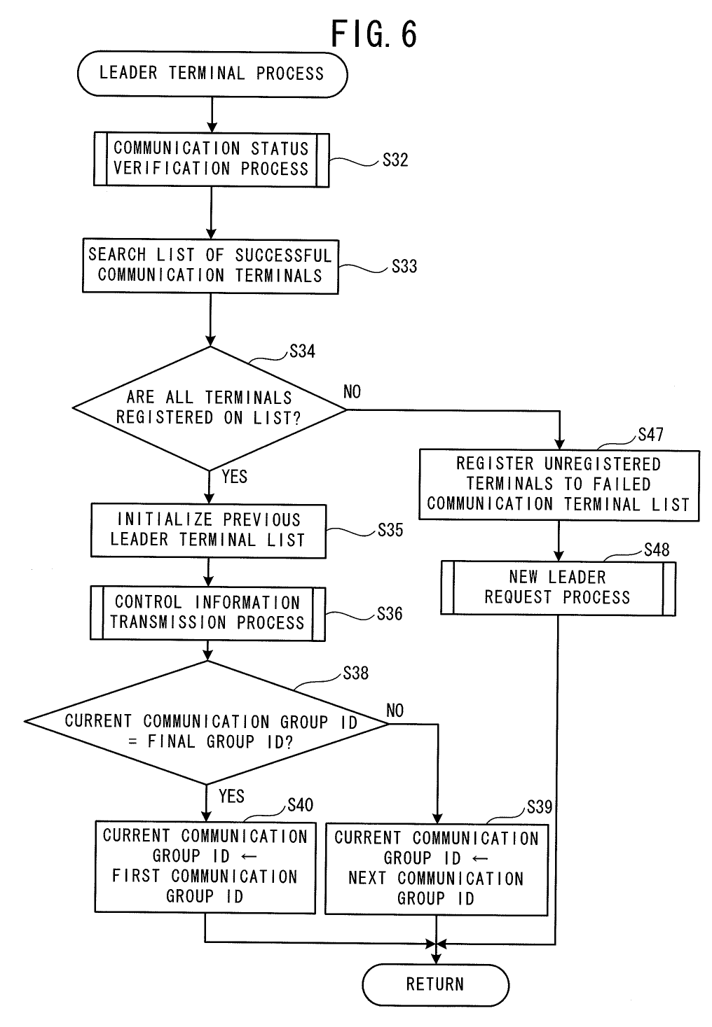

The leader terminal process will be explained with reference to FIG. 6 to FIG. 9. The content of the transceived data 200 in FIG. 4 will also be referred to where appropriate. As shown in FIG. 6, when the leader terminal process is started, first, the leader terminal 1 performs a communication status verification process to check, group by group, whether communication can be performed with each of the member terminals (step S32).

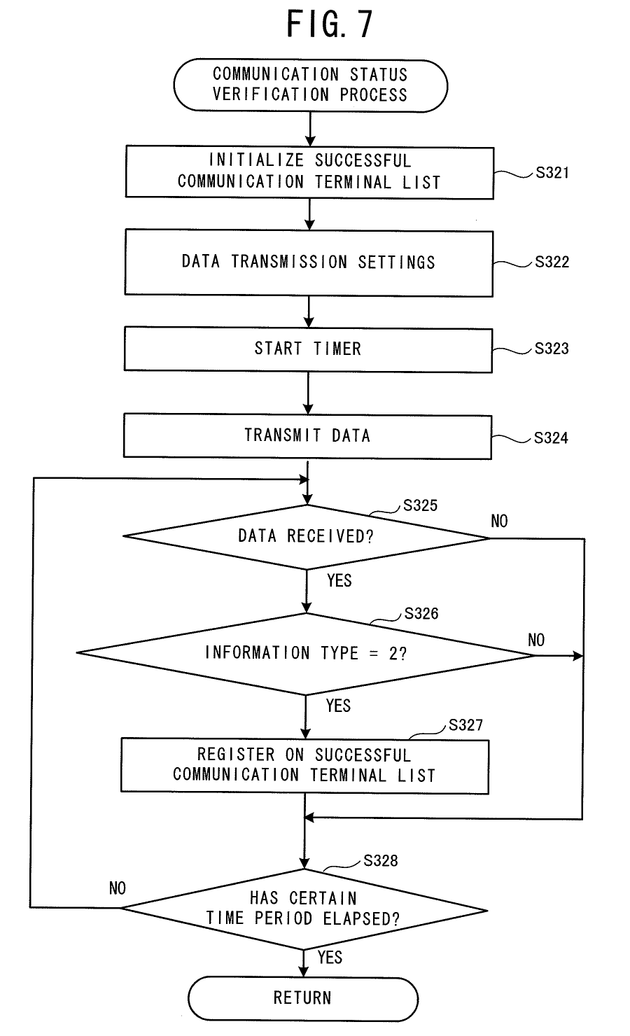

The communication status verification process will be explained in detail with reference to FIG. 7. When the communication status verification process is started, first, the successful communication terminal list stored in the successful communication terminal storage area 32 is initialized (step S321). Then, transmission data settings are made (step S322). As explained above, in the first embodiment, the transceived data 200 has the type of configuration shown in FIG. 4. Here, the ID of the group 3 with which the current leader terminal 1 is to perform communication from now (the current communication group) is set as the transmission destination of the transceived data 200 and “1” is set as the information type. The “1” set as the information type is the “communication status verification” sent to the member terminal 2.

Next, a timer is started in order to measure elapsed time until a response to the transmission data is returned from the member terminal 2 (step S323). Then, the transmission data set in step S322 is transmitted (step S324).

It is next determined whether the leader terminal 1 has received response data from the member terminal 2 (step S325). If the leader terminal 1 has not received the response data (no at step S325), the process advances to step S328 and it is determined whether a certain period of time has elapsed since performing the data transmission at step S323.

If the leader terminal 1 has received the response data from the member terminal 2 (yes at step S325), it is determined whether the information type of the data received by the leader terminal 1 is “2” (step S326). The information type “2” is the “notification of reception of communication status verification” that is transmitted when the member terminal 2 receives the information type “1” data transmission. If the received data information type is “2” (yes at step S326), it is understood that the member terminal 2 that transmitted the data (the transmission source member terminal 2) and the current leader terminal 1 are in a state in which communication is possible. Here, the terminal ID of the transmission source member terminal 2 is retrieved from the received data, registered on the successful communication terminal list of the leader terminal 1, and stored in the successful communication terminal storage area 32 (step S327).

After the end of step S327, or when it is determined in step S326 that the information type of the received data is not “2” (no at step S326), the process advances to step S328 and it is determined whether the certain period of time has elapsed since performing the data transmission at step S323.

If the certain period of time has not elapsed since performing the data transmission at step S323 (no at step S328), the process returns to step S325, waits to receive data from another of the member terminals 2, and repeats the process to determine the information type of the received data. On the other hand, if the certain period of time has elapsed (yes at step S328), the process returns to the leader terminal process.

After returning to the leader terminal process (see FIG. 6), next, the successful communication terminal list stored in the successful communication terminal storage area 32 is searched (step S33). As explained above, only the terminals from which there was a response in the communication status verification process are listed on the successful communication terminal list. The list of the terminals from which there was a response is checked against the all terminal list that is stored in the all terminal list storage area 34. It is then determined whether all of the member terminals 2 in the current communication group, which is the group currently targeted for communication with the leader terminal 1, are registered on the successful communication terminal list (step S34).

If all of the terminals in the current communication group are registered on the successful communication terminal list (yes at step S34), this means that for the current communication group the current leader terminal 1 does not have any cases of failed communication. Accordingly, the previous leader terminal list is initialized (step S35). Then, process is performed to transmit the control information to the current communication group (a control information transmission process) (step S36).

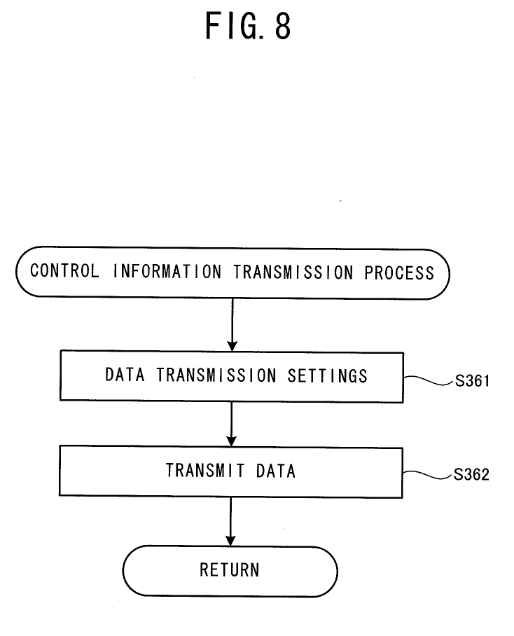

The control information transmission process will be explained in detail with reference to FIG. 8. When the control information transmission process is started, first, transmission data settings are made (step S361). As explained above, in the first embodiment, the transceived data 200 has the type of configuration shown in FIG. 4. Here, the ID of the group with which the leader terminal 1 is to perform communication from now (the current communication group) is set as the transmission destination of the transceived data 200 and “3” is set as the information type. The “3” set as the information type is the “control information” that causes the member terminal 2 to perform a certain process. The content of the process caused to be performed by the member terminal 2 (the control content) may be established in advance, or the control content may be transmitted in a command format with the transmission data. Examples of the process can include, for example, illumination of an LED on the terminal, driving a motor, output of audio and the like. When the transmission data settings are complete, the transmission data is transmitted (step S362) and the process returns to the leader terminal process. The data transmission performed in step S362 is a broadcast transmission, and the ID of the current communication group is set as the transmission destination. Accordingly, each of the member terminals 2 belonging to the current communication group receive the transmission data and respectively perform processing based on the control information (this will be described in more detail later in an explanation of the member terminal process).

After returning to the leader terminal process (see FIG. 6), it is next determined whether the ID of the current communication group is the ID of the final group on the communication group list stored in the communication group storage area 33 (step S38). If the current communication group is not the final group (no at step S38), in order to send the control information to the next group, the ID of the next group is set as the current communication group ID (step S39), and the process returns to the main process. On the other hand, if the current communication group is the final group (yes at step S38), in order to return to the first group and send the control information, the first group ID is set as the current communication group ID (step S40) and the process returns to the main process.

Meanwhile, if as a result of searching the successful communication terminal list, one of the terminals in the current communication group is not registered on the successful communication terminal list (no at step S34), the terminal that is not on the successful communication terminal list is registered on the failed communication terminal list (failed delivery list), and is stored in the failed communication terminal storage area 37 (step S47). Then, as a case of failed communication has occurred with the current leader terminal 1, a new leader request process is performed to request a new leader terminal (step S48). After that, the process returns to the main process.

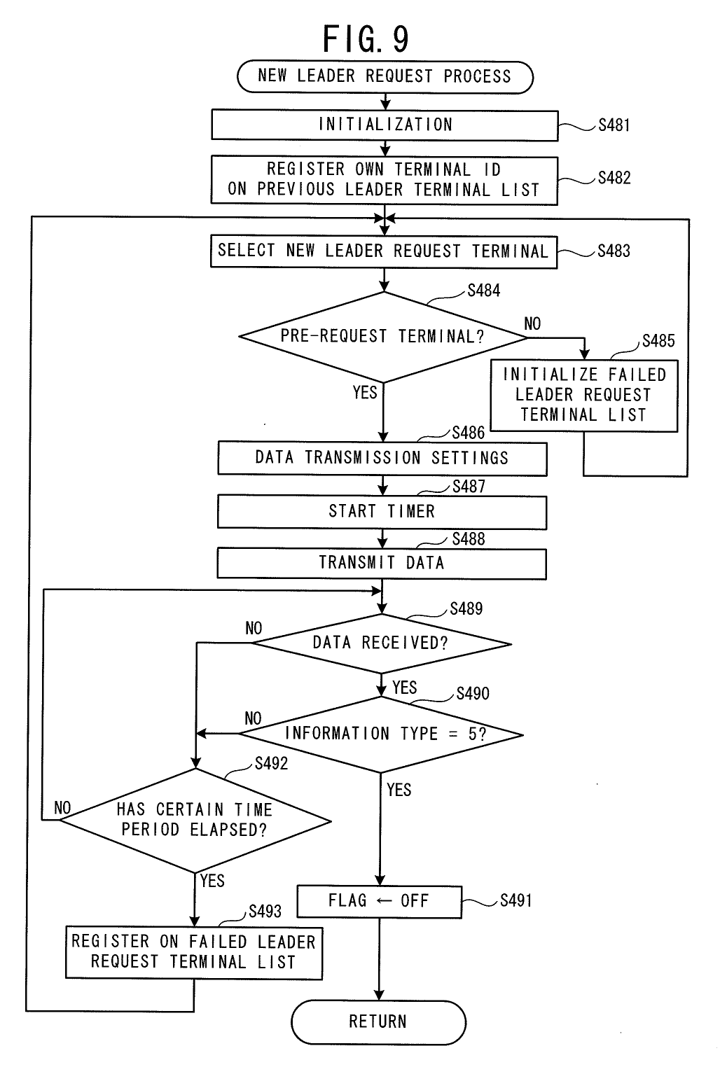

The new leader request process will be explained in detail with reference to FIG. 9. When the new leader request process is started, first, a variety of initialization processes are performed (step S481). Then, the ID of the current leader terminal 1 is registered on the previous leader terminal list, and stored in the previous leader terminal storage area 35 (step S482).

Next, one of the terminals is selected to be requested to be the new leader terminal (step S483). The terminal to be requested to be the new leader terminal is selected from among the terminals remaining after respectively excluding the terminals that are registered on the previous leader terminal list, on the failed leader request terminal list and on the failed communication terminal list. Note that the failed leader request terminal list is the list of the terminals for which the leader request has previously failed. The order of the selection of the terminal for the new leader request may be in the order of a list established in advance, or may be based on information about the processing capabilities of each of the terminals, which are registered on the list in advance. Alternatively, the selection may be random. Moreover, information about the position of each of the terminals may be registered in advance, and the selection may be made in order from the terminals that are positioned close to the terminal with which the communication failure occurred. Further, the leader terminal 1 may create in advance a list of reception signal strengths from each of the terminals, and may select the terminal for which the reception signal strength is weak (the most distant terminal), the terminal for which the reception signal strength is a median value (the terminal with a high likelihood of being centrally positioned), or the terminal with the reception signal strength that is closest to the reception signal strength of the terminal for which the communication failure occurred (the terminal with a high likelihood of being positioned close to the terminal for which the communication failure occurred). Note that in the present embodiment, the selection is made randomly.

Next, it is determined whether there is a terminal that is able to receive the new leader request in step S483 (a pre-request terminal) (step S484). In step S483, from among the candidates for the new leader terminal, the terminals registered on the three types of list described above are excluded, so it is possible that none of the terminals remain available as the candidates to become the new leader terminal. In this case (no at step S484), the failed leader request terminal list is initialized (step S485) and the process returns to step S483. As a result, in step S483, the terminal requested to be the new leader terminal can be selected from among the terminals that were registered on the failed leader request terminal list but are not registered on the previous leader terminal list and the failed communication terminal list. Note that when selecting the new leader terminal in step S483, not all the three types of list need necessarily be used, and the selection may be made by excluding any of the terminals registered on the failed communication terminal list. In this case, the process at step S485 is unnecessary. The previous leader terminal list may also be initialized in step S485.

If there is a terminal that is able to receive the new leader request (the pre-request terminal) (yes at step S484), next, settings are made for the data to be transmitted to the terminal that is to be requested to be the new leader terminal (hereinafter referred to as the “new leader request terminal”) (step S486). In other words, the ID of the new leader request terminal is set as the transmission destination of the transmission data, and the information type is set as “4”, namely the “new leader request”. Further, so that the new leader request terminal can ascertain the terminals that have previously been the leader terminal, the previous leader terminal list is called from the previous leader terminal storage area 35 and attached to the transmission data.

Next, a timer is started in order to measure a response time from the new leader request terminal with regard to the new leader request (step S487). Then, the data set in step S486 is transmitted to the new leader request terminal (step S488). The transmission of the data is a broadcast transmission, and the ID of the new leader request terminal is set as the transmission destination. When the member terminal 2 that has the ID receives the transmission data, it transmits the notification of reception of the new leader request to the leader terminal 1, as explained later in the description of the member terminal process.

It is next determined whether the leader terminal 1 has received the notification of reception of the new leader request from the new leader request terminal (step S489). When the leader terminal 1 receives the data from the member terminal 2 (yes at step S489), it is determined whether the information type of the received data is “5” (step S490). The information type “5” is the “notification of reception of new leader request” transmitted by the member terminal 2 after receiving the information type “4” data transmission. When the information type of the received data is “5” (yes at step S490), it is understood that the member terminal 2 that transmitted the data can become the new leader terminal 4. Therefore, the current leader terminal 1, which issued the new leader request, stops being the leader terminal 1 and transfers to become the member terminal 2. To that end, the leader terminal 1 control flag is switched “OFF” (step S491). The process then returns to the leader terminal process and further to the main process. As the control flag on the terminal is switched “OFF”, in the main process, the terminal performs processing as the member terminal 2 (no at step S20 on FIG. 5).

On the other hand, if the current leader terminal 1 has not received the data from the member terminal 2 (no at step S489), or if the information type of the received data is not “5” (no at step S490), the process advances to step S492 and it is determined whether a certain period of time has elapsed since the performing of the data transmission in step S488 (step S492). If the certain period of time has not elapsed since the data transmission (no at step S492), the process returns to step S489, waits to receive data, and repeats the process to determine the information type of the received data. After the data transmission performed in step S488, if the certain period of time has elapsed without any data being received (yes at step S492), the communication between the selected new leader terminal 4 and the leader terminal 1 has failed, which means that the selected terminal is unable to become the leader terminal. As a consequence, the transmission destination terminal ID set in step S486 is registered on the failed leader request terminal list and stored in the failed leader request terminal storage area 36 (step S493). Then, in order to newly select the new leader request terminal, the process returns to step S483 and repeats the process. Through the above, the new leader request process ends with the new leader terminal 4 in a requested state, and the process passes through the leader terminal process and returns to the main process.

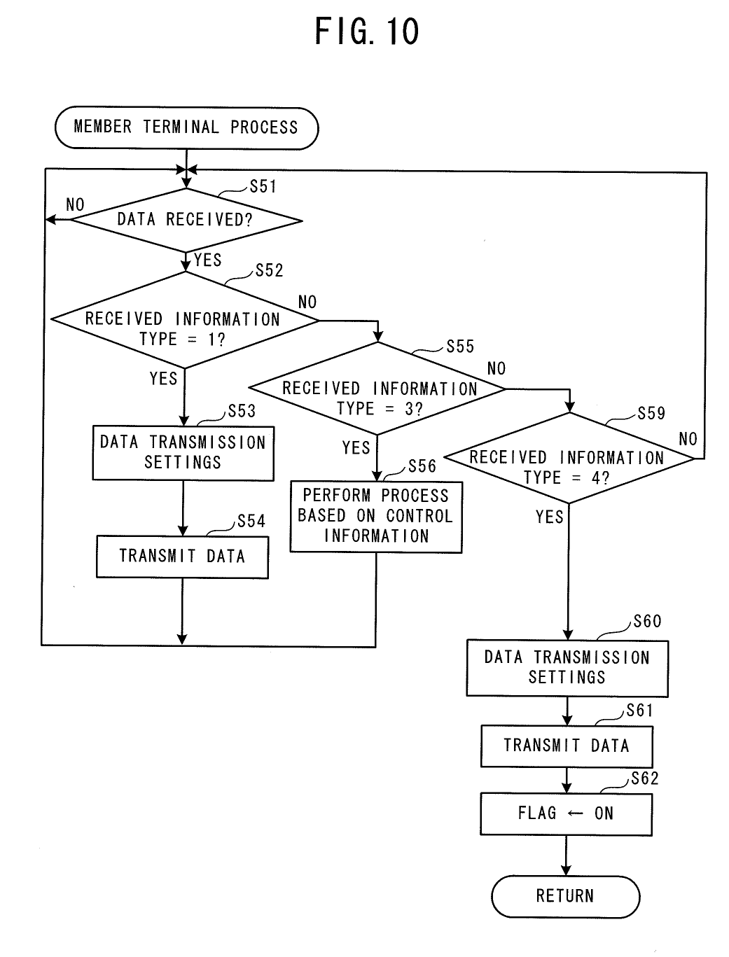

The member terminal process will be explained with reference to FIG. 10. With respect to the main process (see FIG. 5), the member terminal process is the process that is performed when the control flag of the terminal is “OFF” (no at step S20).

When the member terminal process is started, first, it is determined whether the member terminal 2 has received data from the leader terminal 1 (step S51). In the first embodiment, the data is a broadcast transmission and each of the member terminals 2 perform reception by sorting and selecting the data for which the terminal's own ID or the ID of the group to which the terminal belongs is set as the transmission destination. If the data is not received (no at step S51), namely, if there is no transmission for which the terminal's own ID or the ID of the group to which the terminal belongs is set as the transmission destination, the member terminal 2 operates on stand-by until reception of the next data.

When the member terminal 2 has received the data from the leader terminal 1 (yes at step S51), next, the information type of the received data is determined in order (step S52, step S55 and step S59), and the process is performed in accordance with the type.

First, it is determined whether the information type of the received data is “1” (step S52). If the information type of the received data is “1” (yes at step S52), as that is the “communication status verification” from the leader terminal 1, data settings are made in order to transmit a message in response to the communication status verification (step S53). In other words, the transmission source terminal ID of the received data (the ID of the current leader terminal 1) is set as the transmission destination for the transmission data, and the information type is set as “2”. The information type “2” is the “notification of reception of communication status verification”. Then, the set data is transmitted (step S54), and the process returns to step S51 and waits to receive data.

If the information type of the received data is not “1” (no at step S52), it is next determined whether the information type of the received data is “3” (step S55). If the received information type is “3” (yes at step S55), that is an instruction from the leader terminal 1 to perform an operation, and therefore a process that is established in advance, or a process that is based on a command transmitted with the control information, is performed (step S56). The process then returns to step S51 and waits to receive data. Note that as well as performing the process in accordance with the control information, the process may be set up so that data indicating that the process has been performed is transmitted to the leader terminal 1.

If the information type of the received data is not “3” (no at step S55), it is next determined whether the received information type is “4” (step S59). If the received information type is “4” (yes at step S59), that is the “new leader request” from the current leader terminal 1 and transmission data settings are therefore made (step S60) in order to transmit an acceptance message in response to the new leader request. In other words, the transmission source terminal ID of the received data (the ID of the current leader terminal 1) is set as the transmission destination for the transmission data, and the information type is set as “5”. The information type “5” is the “notification of reception of new leader request”. Then, the set data is transmitted (step S61), and, as the member terminal will function as the new leader terminal from the next process, the control flag is switched “ON” (step S62). The process then returns to the main process. As the control flag is switched “ON”, in the next process of the main process, the terminal performs the leader terminal process (yes at step S20; step S30 on FIG. 5).

If the information type of the received data is not “4” (no at step S59), the process returns to step S51 as it is and waits to receive data.

As explained above, in the wireless communication system 100 according to the first embodiment, each of the communication terminals stores the ID of all the terminals and functions as either the leader terminal 1 or the member terminal 2. Further, each of the communication terminals is identified as being either the leader terminal 1 or the member terminal 2 by whether the control flag is switched “ON” or “OFF”. When the control flag is switched “ON”, the communication terminal performs processing as the leader terminal 1. On the other hand, when the control flag is switched “OFF”, the communication terminal performs processing as the member terminal 2. In the processing as the leader terminal 1, the communication terminal checks the communication status with the member terminals group by group, transmits the control information group by group, and causes each of the member terminals to perform processing. When checking the communication status, if it becomes evident that one of the member terminals is unable to communicate with the current leader terminal 1, a new leader terminal is selected to replace the current leader terminal 1 and is requested as the new leader terminal. If the current leader terminal receives a response from the new leader request terminal that is the notification of reception of the new leader request, the current leader terminal 1 switches its control flag “OFF”, thus stopping being the leader terminal 1, and becoming the member terminal 2. Accordingly, if one of the member terminals 2 is unable to communicate with the leader terminal 1 due to the presence of a shield or due to movement of the terminal etc., another of the terminals can be made the leader terminal 1. The new leader request terminal is selected from the list of the terminals that have not previously experienced failed communication, and that have also transmitted the response to the transmission of the new leader request, and is then made the new leader terminal. In this way, the new leader terminal is one of the terminals that has no failed communication record, thus maintaining a high probability of successful communication.

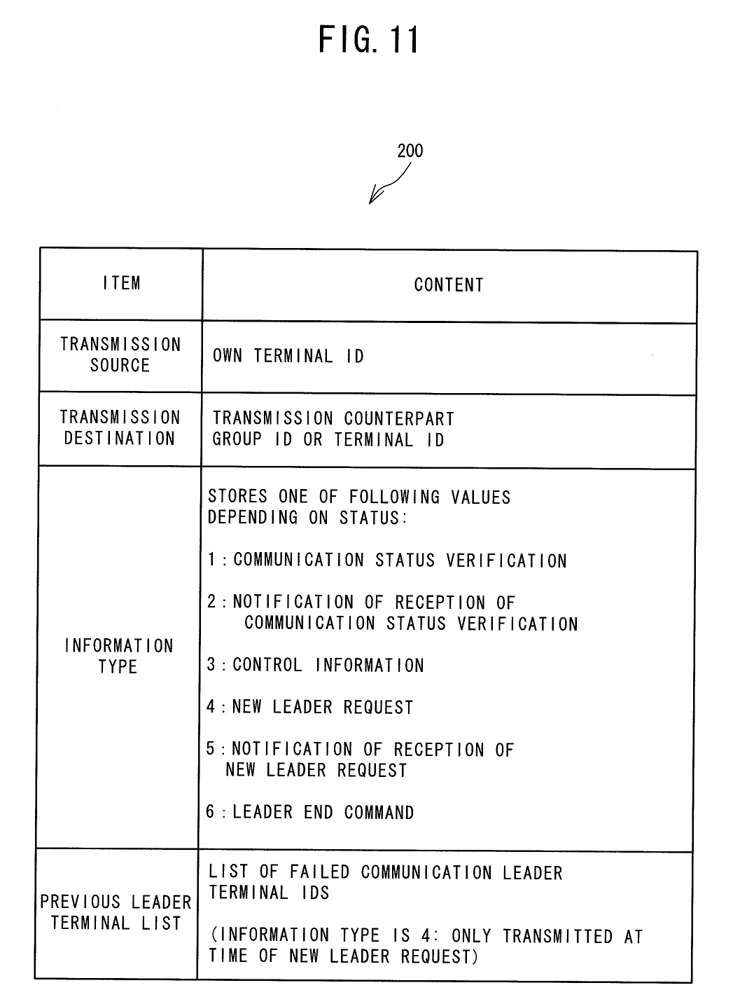

Next, a second embodiment will be explained with reference to FIG. 11 to FIG. 17, in which, in order to repeat control of the member terminals 2 group by group over a fixed cycle, a terminal is provided to measure time.

In the wireless communication system 100 according to the second embodiment, the transceived data 200 is transmitted and received as shown in FIG. 11. As shown in FIG. 11, the transceived data 200 includes the four items, namely the transmission source information, the transmission destination information, the information type and the previous leader terminal list. The ID of the terminal transmitting the data is set in the transmission source information. The group ID or the terminal ID of the transmission counterpart terminal is set in the transmission destination information. As broadcast transmission is performed in the wireless communication system 100, the transmission counterpart ID is essential. When the ID set in the transmission destination information of the received data matches the terminal's own ID, or matches the ID of the group to which the terminal itself belongs, each of the terminals determines that the data is targeted to itself. One of a value from 1 to 6 is set in the information type. Each of the values is allocated to the following type of functions. 1: Communication status verification; 2: Notification of reception of communication status verification; 3: Control information; 4: New leader request; 5: Notification of reception of new leader request; 6: Leader end command. When the information type is “4”, the previous leader terminal list, that is the list of the terminals that were previously the leader terminal, is attached.

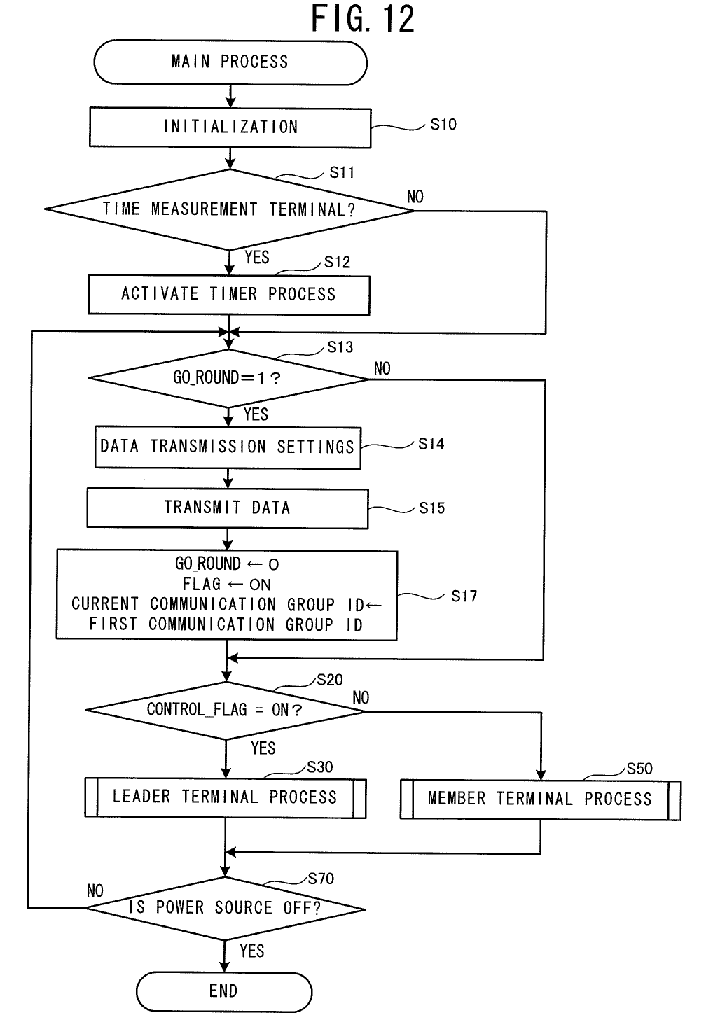

In the second embodiment, the communication terminal repeatedly performs the main process from when the power source is switched on to when the power source is switched off, as shown in FIG. 12. During the main process, when the communication terminal is the current leader terminal 1, the communication terminal performs processing as the leader terminal. On the other hand, if the communication terminal is the member terminal 2, the communication terminal performs processing as the member terminal.

As shown in FIG. 12, when the power source of the communication terminal is turned on, first, the communication terminal performs the initialization process, including clearing certain content of the communication terminal RAM 30 and so on (step S10). It is then determined whether the current communication terminal is a time measurement terminal to measure time (step S11). In the second embodiment, one of the terminals belonging to the wireless communication system 100 is designated in advance as the time measurement terminal. For example, the initial leader terminal 1 may be designated as the time measurement terminal. If the communication terminal is the time measurement terminal (yes at step S11), a timer process is started (step S12). On the other hand, if the current communication terminal is not the time measurement terminal (no at step S11), the process advances as it is to step S13.

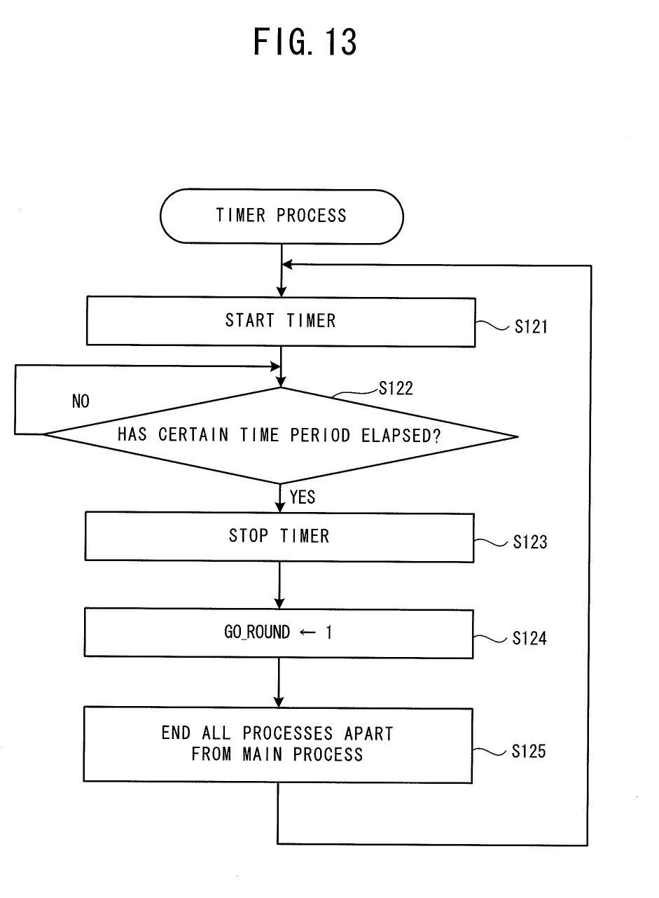

The timer process will be explained in detail with reference to FIG. 13. The timer process is the process to measure time such that when a certain period of time has elapsed, all the processes are ended and the time measurement terminal is made the leader terminal 1. After the timer process is activated by the main process, it is repeatedly performed, and so the time measurement terminal returns to be the leader terminal each time the certain period of time elapses.

When the timer process is activated, first, a timer is started (step S121). Then, after the timer is started, it is determined whether the certain period of time has elapsed (step S122). If the certain period of time has not elapsed (no at step S122), the process operates on stand-by until the certain period of time has elapsed. When the certain period of time has elapsed (yes at step S122), the timer is stopped (step S123), and “1” is set as the “go_round” variable (step S124). The process then ends all the processes apart from the main process, and returns to the main process (step S125). The process then returns to step S121, and re-starts timer. By repetition of the above process, the processing by the time measurement terminal is returned to the main process each time the certain period of time elapses.

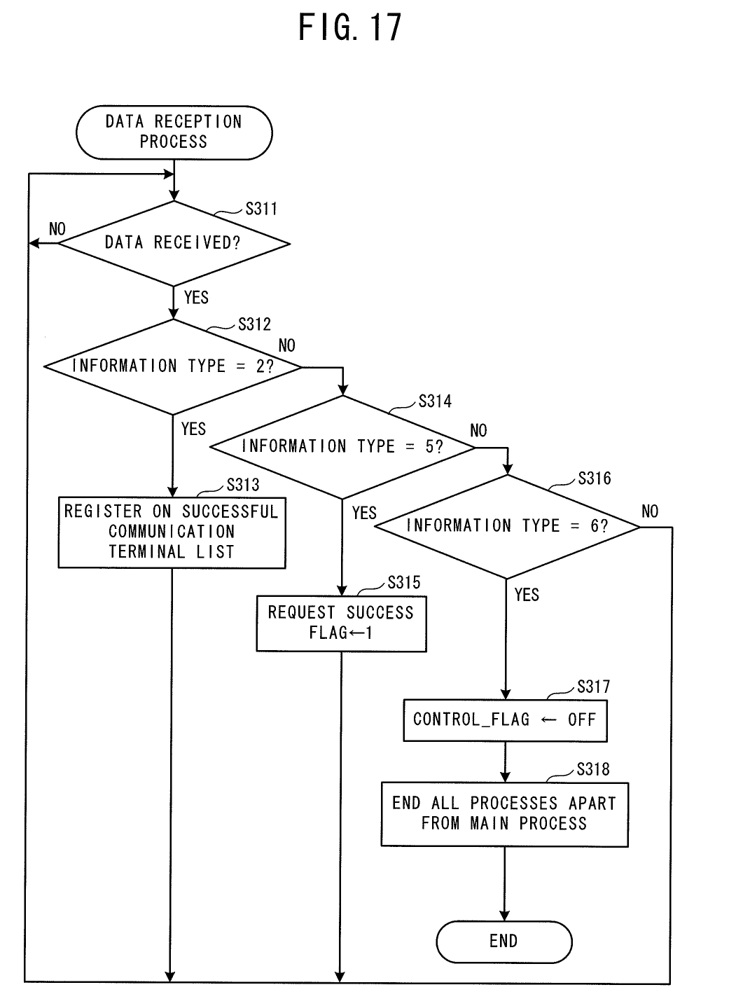

After completing activation of the timer process, the process returns to the main process (see FIG. 12). Next, it is determined whether the “go_round” variable is “1”. Due to the timer process (see FIG. 13), when the certain period of time has elapsed, “1” is set as the “go_round” variable, so if the “go_round” variable is “1” (yes at step S13), transmission data settings are made (step S14) in order to transmit the leader end command to all the terminals. In other words, an ID that designates all the groups is set as the transmission destination of the transmission data, and “6” is set as the information type. The information type “6” is the “leader end command” that causes the current leader terminal 1 to stop being the leader. Then, the set data is transmitted (step S15). As explained later, when the leader terminal 1 receives the transmitted data, the control flag is switched “OFF”, and the process returns to the main process (see FIG. 17), thus the terminal is no longer the leader terminal 1 as of that point in time and becomes the member terminal 2.

In the above way, the process is ended after the certain period of time has elapsed, and “0” is thus set as the “go_round” variable, the control flag (control_flg) is switched “ON” and the ID of the first communication group on the communication group list is set as the current communication group to be targeted for communication from now (step S17). As the control flag is switched “ON” as a result of this process, the time measurement terminal therefore replaces the leader terminal up to that time and itself becomes the leader terminal.

It is next determined whether “1” is stored in the control flag storage area 31. In other words, it is determined whether the control flag (control_flg) is switched “ON” (step S20).

When the control flag is switched “ON” (yes at step S20), the leader terminal process is performed (step S30). On the other hand, if the control flag is switched “OFF” (no at step S20), the member terminal process is performed (step S50). The leader terminal process will be explained later. As the member terminal process is the same as for the first embodiment, an explanation will be omitted here.

When the leader terminal process or the member terminal process ends, it is determined whether the current leader terminal 1 power source is switched “OFF” (step S70). If the power source is switched “OFF” (yes at step S70), all the processes are ended. If the power source is not switched “OFF” (no at step S70), the process returns to step S20 and the process is repeated.

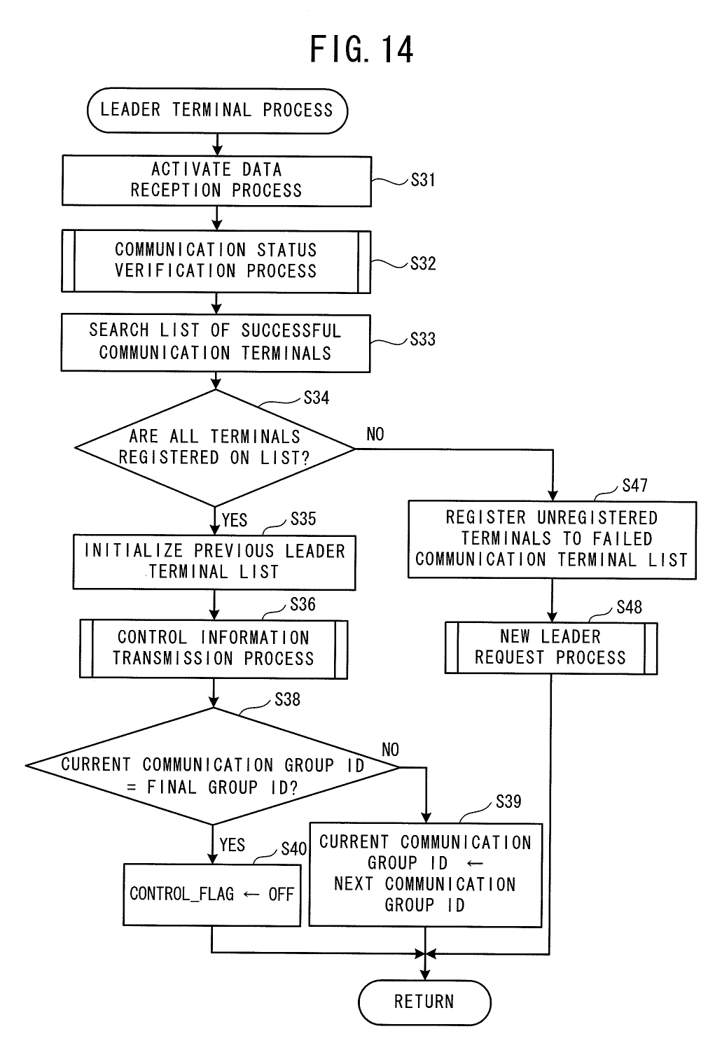

The leader terminal process will be explained with reference to FIG. 14 to FIG. 17. As shown in FIG. 14, when the leader terminal process is started, first a data reception process is activated (step S31). In the data reception process, data is received from the other terminals, and different processes are performed for each of the information types of the received data. Moreover, if the terminal is the time measurement terminal, the data reception process is repeatedly performed until the certain period of time has elapsed after activation of the timer process (see FIG. 13, step S125). If the terminal is not the time measurement terminal, the data reception process is repeatedly performed until the leader end command, that is the instruction to end the process, is transmitted from the time measurement terminal (see FIG. 17, step S318).

The data reception process will be explained with reference to FIG. 17. When the data reception process is activated, it is first determined whether the leader terminal 1 has received the data (step S311). If the leader terminal 1 has not received the data (no at step S311), it operates on stand-by until it receives the data. If the leader terminal 1 has received the data (yes at step S311), next, the information type of the received data is determined in order (step S312, step S314 and step S316), and the process is performed in accordance with the information type.

First, it is determined whether the information type of the data received by the leader terminal 1 is “2” (step S312). The information type “2” is the “notification of reception of communication verification status” that is transmitted by the member terminal 2 when the information type “1” data transmission is received. If the information type is “2” (yes at step S312), it is understood that the member terminal 2 that transmitted the data (the transmission source member terminal 2) and the current leader terminal 1 are in a state in which communication is possible. As a consequence, the terminal ID of the transmission source member terminal 2 is retrieved from the received data, registered on the successful communication terminal list of the leader terminal 1, and stored in the successful communication terminal storage area 32 (step S313). Then, the process returns to step S311 and waits to receive data. The successful communication terminal list is initialized by the communication status verification process, to be explained later. Then, each time the data reception process performed in parallel performs step S313, the terminal for which the communication is successful is added to the successful communication terminal list.

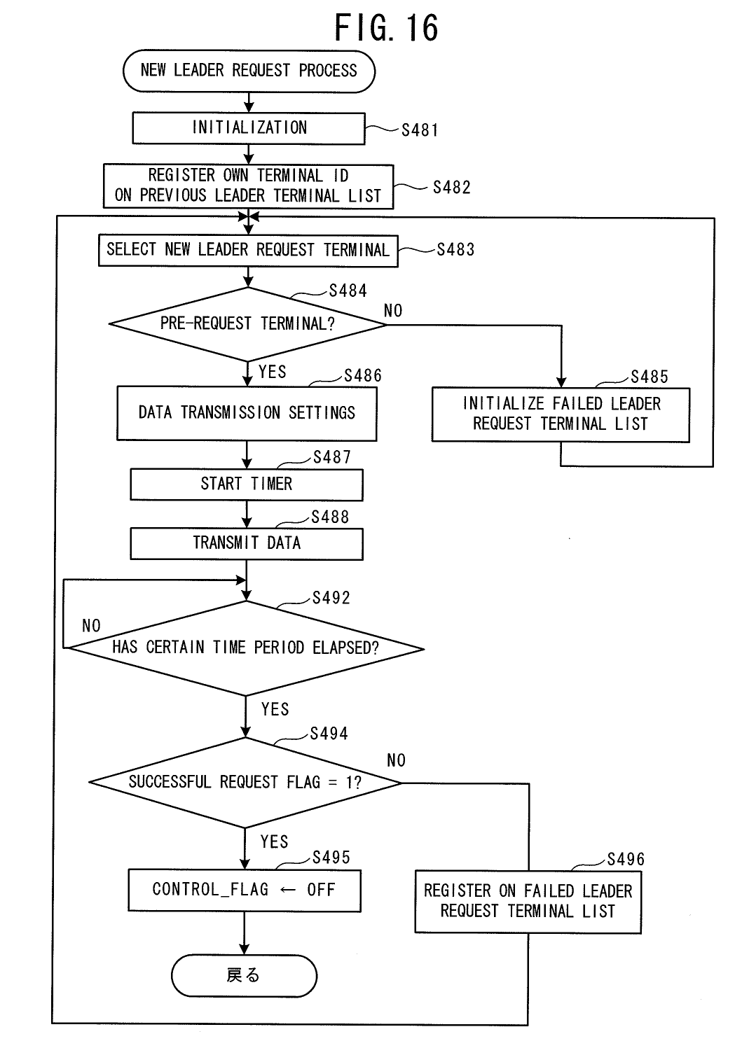

If the information type of the data received by the leader terminal 1 is not “2” (no at step S312), it is next determined whether the received data information type is “5” (step S314). The information type “5” is the “notification of new leader request” transmitted by the member terminal 2 when it receives the information type “4” data transmission. If the received data information type is “5” (yes at step S314), it is understood that the terminal that transmitted the data is able to become the new leader terminal 4 and “1” is stored in a leader terminal 1 successful request flag (step S315). As described later, the successful request flag is referred to during the new leader request process (see FIG. 16, step S494). Then, the process returns to step S311 and waits to receive data.

If the information type of the data received by the leader terminal 1 is not “5” (no at step S314), it is next determined whether the received data information type is “6” (step S316). The information type “6” is the “leader end command” that is transmitted by the time measurement terminal after the certain period of time has elapsed in order to request the leader terminal 1 to immediately stop performing processing as the leader terminal 1. Here, if the received information data type is “6” (yes at step S316), the control flag of the current leader terminal 1 is switched “OFF” (step S317), all the processes apart from the main process are ended and the process returns to the main process (step S318). The data reception process is also ended.

When the process returns to the leader terminal process (see FIG. 14), after the data reception process is activated (step S31), next the communication status verification process is activated, in which it is checked group by group whether communication is possible with each of the member terminals 2 (step S32).

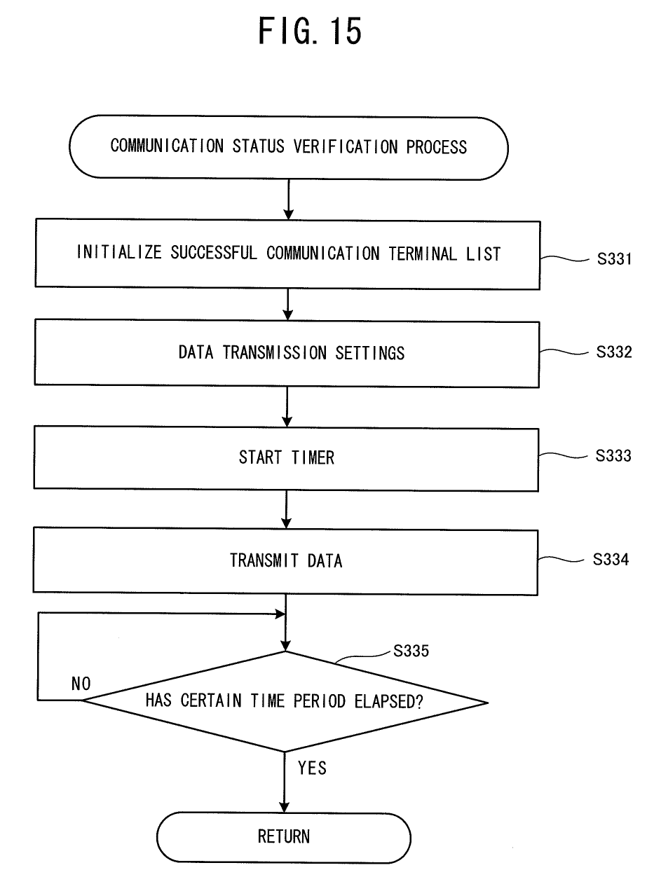

The communication status verification process will be explained in detail with reference to FIG. 15. When the communication status verification process is started, first, the successful communication terminal list that is stored in the successful communication terminal storage area 32 of the leader terminal 1 is initialized (step S331). Then transmission data settings are made (step S332). As explained above, in the second embodiment, the transceived data 200 has the type of configuration shown in FIG. 11, and therefore the ID of the group with which the leader terminal 1 is to perform communication from now (the current communication group) is set as the transmission destination and “1” is set as the information type. The “1” set as the information type is the “communication status verification” sent to the member terminal 2.

Next, in order to measure a certain period of time until a response is returned from the member terminal 2, a timer is started (step S333). Then, the transmission data set in step S332 is transmitted (step S334). Then, it is determined whether the certain period of time has elapsed (step S335). If the certain period of time has not elapsed since the transmission of the transmission data (no at step S335), the process operates as it is on stand-by. On the other hand, if the certain period of time has elapsed since the transmission of the transmission data (yes at step S335), the process returns to the leader terminal process. Here, while waiting for the certain period of time to elapse, the data reception process (see FIG. 17) is continually performed and therefore each time the notification of reception of communication status verification is received from each of the member terminals 2, the ID of the member terminal 2 is registered on the successful communication terminal list (see FIG. 17, step S313).

When the process returns to the leader terminal process (see FIG. 14), next the successful communication terminal list that is stored in the successful communication terminal storage area 32 is searched (step S33). The ID of the terminal or terminals from which data has been received with the information type “2” as part of the data reception process during a certain stand-by period during the communication status verification process, namely the ID of the terminals that are able to communicate with the leader terminal 1, are listed on the successful communication terminal list that is searched. The terminals with which communication is possible are matched against the all terminal list that is stored in the all terminal storage area 34. It is then determined whether all the member terminals in the current communication group, which is the group currently communicating with the leader terminal 1, are registered on the successful communication terminal list (step S34).

If all of the member terminals in the current communication group are registered on the successful communication terminal list (yes at step S34), this means that for the current communication group the current leader terminal 1 does not have any cases of failed communication. Accordingly, the previous leader terminal list is initialized (step S35). Then, a process is performed to transmit the control information to the current communication group (the control information transmission process) (step S36). The details of the control information transmission process are the same as explained for the first embodiment with reference to FIG. 8, and an explanation is therefore omitted here.

Next, it is determined whether the ID of the current communication group is the ID of the final group on the communication group list stored in the communication group storage area 33 (step S38). If the current communication group is not the final group (no at step S38), in order to send the control information to the next group, the ID of the next group is set as the current communication group ID (step S39), and the process returns to the main process (see FIG. 12). On the other hand, if the current communication group is the final group (yes at step S38), after switching the control flag (control_flg) to “OFF” (step S40), the process returns to the main process (see FIG. 12).

Meanwhile, if as a result of searching the successful communication terminal list, one of the terminals in the current communication group is not registered on the successful communication terminal list (no at step S34), the terminal that is not on the successful communication terminal list is registered on the failed communication terminal list and is stored in the failed communication terminal storage area 37 (step S47). Then, as a case of failed communication has occurred with the current leader terminal 1, the new leader request process is performed to request the new leader terminal (step S48). After that, the process returns to the main process (see FIG. 12).

The new leader request process will be explained in detail with reference to FIG. 16. When the new leader request process is started, first, the varieties of initialization processes are performed (step S481). Then, the ID of the current leader terminal 1 is registered on the previous leader terminal list, and stored in the previous leader terminal storage area 35 (step S482).

Next, one of the terminals is selected to be requested to be the new leader terminal (step S483). The terminal to be requested to be the new leader terminal is selected from among the terminals remaining after respectively excluding the terminals that are registered on the previous leader terminal list, on the failed leader request terminal list and on the failed communication terminal list. Note that the failed leader request terminal list is the list of the terminals for which the leader request has previously failed. The order of the selection of the terminal for the new leader request may be in the order of a list established in advance, or may be based on information about the processing capabilities of each of the terminals, which are registered on the list in advance. Alternatively, the selection may be random. Moreover, information about the position of each of the terminals may be registered in advance, and the selection may be made in order from the terminals that are positioned close to the terminal for which the communication failure occurred. Further, the leader terminal 1 may create in advance a list of reception signal strengths from each of the terminals, and may select the terminal for which the reception signal strength is weak (the most distant terminal), the terminal for which the reception signal strength is a median value (the terminal with a high likelihood of being centrally positioned), or the terminal with the reception signal strength that is closest to the reception signal strength of the terminal for which the communication failure occurred (the terminal with a high likelihood of being positioned close to the terminal for which the communication failure occurred). Note that in the second embodiment, the selection is made randomly.

It is then determined whether there is a terminal that is able to receive the new leader request in step S483 (the pre-request terminal) (step S484). In step S483, from among the candidates for the new leader terminal, the terminals registered on the three types of list described above are excluded, so it is possible that none of the terminals remain available to as the candidates to become the new leader terminal. In this case (no at step S484), the failed leader request terminal list is initialized (step S485) and the process returns to step S483. As a result, in step S483, the terminal requested to be the new leader terminal can be selected from among the terminals that were registered on the failed leader request terminal list but are not registered on the previous leader terminal list and the failed communication terminal list. Note that when selecting the new leader terminal in step S483, not all the three types of list need necessarily be used, and the selection may be made by excluding any of the terminals registered on the failed communication terminal list. In this case, the process at step S485 is unnecessary. The previous leader terminal list may also be initialized in step S485.

If there is a terminal that is able to receive the new leader request (the pre-request terminal) (yes at step S484), next, settings are made for the data to be transmitted to the new leader request terminal (step S486). In other words, the ID of the new leader request terminal is set as the transmission destination of the transmission data, and the information type is set as “4”, namely the “new leader request”. Further, so that the new leader terminal 4 can ascertain the terminals that have previously been the leader terminal, the previous leader terminal list is called from the previous leader terminal storage area 35 and attached to the transmission data.

Next, in order to measure the response time from the new leader request terminal with regard to the new leader request, the timer is started (step S487). Then, the data set in step S486 is transmitted to the new leader request terminal (step S488). It is then determined whether the certain period of time has elapsed since the data transmission (step S492). If the certain period of time has not elapsed (no at step S492), the process operates on stand-by until the certain period of time has elapsed. During the stand-by period also, the above-described data reception process (see FIG. 17) is continually performed, and so, when the new leader request terminal receives the data transmitted at step s488, the information type “5”, namely the “notification of reception of new leader request” is transmitted and received (yes at step S314). Then, in this case, the successful request flag is set as “1” (step S315).

If the certain period of time has elapsed since the data transmission (yes at step S492), next, it is determined whether “1” is stored in the successful request flag (step S494). As described above, when the notification of reception of the new leader request is received during the data reception process, “1” is stored in the successful request flag (see FIG. 17, step S315).

When the successful request flag is “1” (yes at step S494), the new leader terminal 4 is decided and so the current leader terminal 1 stops functioning as the leader terminal 1, and, in order to transfer to become the member terminal 2, it switches its control flag “OFF” (step S495). Then, the process returns to the leader terminal process and further to the main process. In the main process, as the control flag is switched “OFF”, the terminal performs processing as the member terminal (see FIG. 12, no at step S20; step S50).

When the control flag is not “1” (no at step S494), the communication has failed between the selected new leader terminal 4 and the current leader terminal 1, which means that the selected terminal cannot become the leader terminal. Therefore, the transmission destination terminal ID set in step S486 is registered on the failed leader request terminal list and stored in the failed leader request terminal storage area 36 (step S496). Then, in order to newly select the new leader request terminal, the process returns to step S483 and the process is repeated. In the above way, the new leader request process ends with the successful new leader request, the process passes through the leader terminal process (see FIG. 14), and returns to the main process (see FIG. 12).

As explained above, in the wireless communication system 100 according to the second embodiment, a specific one of the communication terminals functions constantly as the time measurement terminal, and, each time the certain period of time elapses, when the leader terminal 1 is present at that point in time, the time measurement terminal causes the leader terminal to stop performing processing as the leader terminal and the time measurement terminal becomes the leader terminal. As a consequence, the system can be effective utilized when it is wished to periodically perform synchronous communication group by group at a fixed time interval.

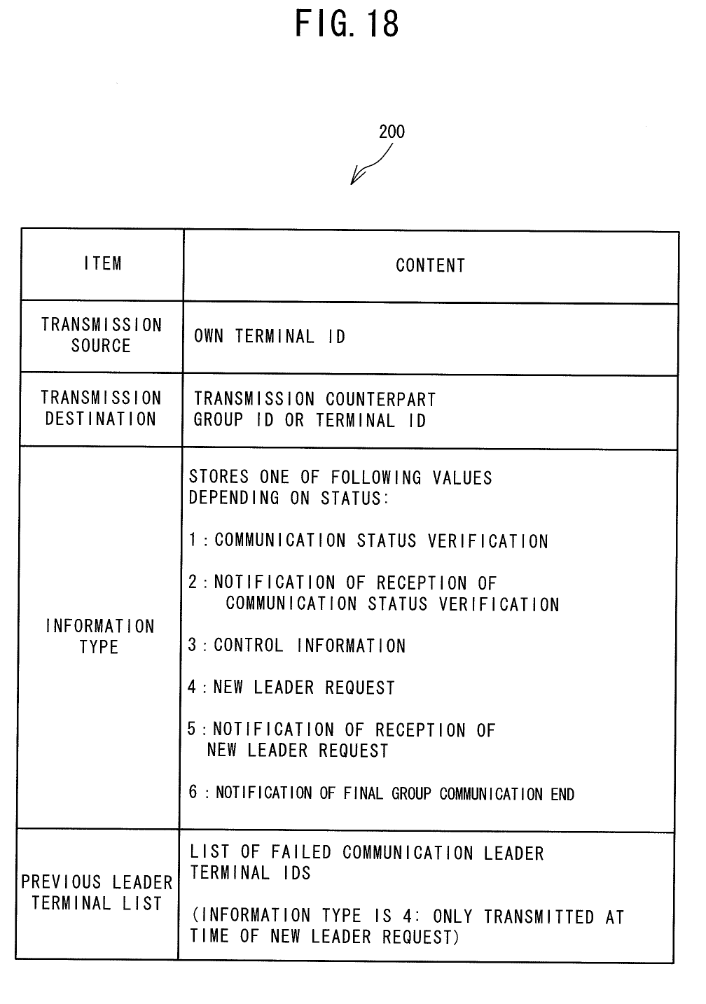

Next, a third embodiment will be explained with reference to FIG. 18 to FIG. 21. In the third embodiment, in the same way as the second embodiment, the terminal to measure time is provided, in order to repeat control group by group over a fixed cycle with regard to the member terminals 2. Here, the leader terminal 1 is not immediately replaced when the certain period of time has elapsed, but the leader terminal 1 is replaced at the point in time at which the transmission of the control information to all the groups is completed.

In the wireless communication system 100 according to the third embodiment, as shown in FIG. 18, the transceived data 200 is transmitted and received. As shown in FIG. 18, the transceived data 200 includes the four items, namely the transmission source information, the transmission destination information, the information type and the previous leader terminal list. The ID of the terminal transmitting the relevant data is set in the transmission source information. The ID of the transmission counterpart group or the ID of the transmission counterpart terminal is set in the transmission destination information. As broadcast transmission is performed in the wireless communication system 100, the transmission counterpart ID is essential. When the ID set in the transmission destination information of the received data matches the terminal's own ID, or matches the ID of the group to which the terminal belongs, each of the terminals determines that the data is targeted to itself. One of a value from 1 to 6 is set in the information type. Each of the values is allocated to the following type of functions. 1: Communication status verification; 2: Notification of reception of communication status verification; 3: Control information; 4: New leader request; 5: Notification of reception of new leader request; 6: Notification of final group communication end. When the information type is “4”, the previous leader terminal list, that is the list of the terminals that have previously been the leader terminal, is attached.

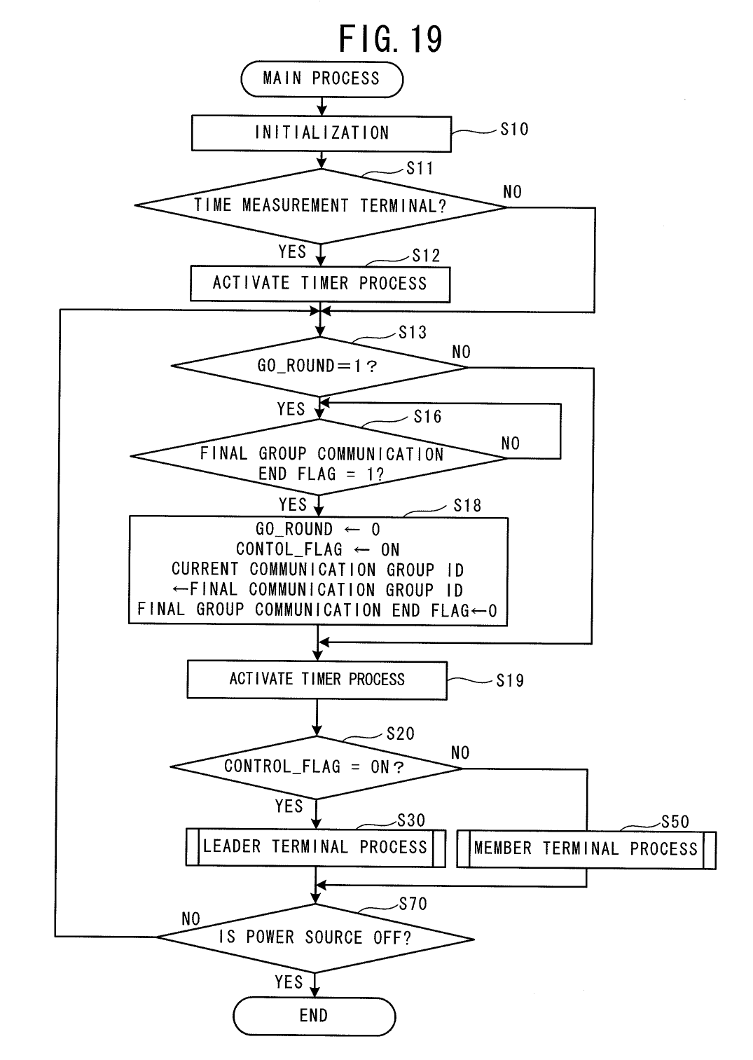

In the third embodiment, the communication terminal repeatedly performs the type of main process shown in FIG. 19 from when the power source is switched on to when the power source is switched off. During the main process, if the communication terminal is the current leader terminal 1, the communication terminal performs processing as the leader terminal. On the other hand, if the communication terminal is the member terminal 2, the communication terminal performs processing as the member terminal.

As shown in FIG. 19, when the power source of the communication terminal is turned on, first, the communication terminal performs the initialization process, including clearing certain content of the communication terminal RAM 30 and so on (step S10). It is then determined whether the current communication terminal is the time measurement terminal to measure time (step S11). In the third embodiment, one of the terminals belonging to the wireless communication system 100 is designated as the time measurement terminal in advance. For example, the initial leader terminal 1 may be designated as the time measurement terminal. If the communication terminal is the time measurement terminal (yes at step S11), the timer process is started (step S12). On the other hand, if the current communication terminal is not the time measurement terminal (no at step S11), the process advances as it is to step S13. Details of the timer process are the same as described for the second embodiment with reference to FIG. 13, and an explanation is therefore omitted here.

Next, it is determined whether the “go_round” variable is “1” (step S13). Due to the timer process (see FIG. 13), when the certain period of time has elapsed, “1” is set as the “go_round” variable. Here, if the “go_round” variable is not “1” (no at step S13), the process advances as it is to step S19. If the “go_round” variable is “1” (yes at step S13), it is next determined whether “1” is stored in a final group communication end flag (step S16). In the leader terminal process, when the transmission of the control information to the final group is complete, the information type “6”, namely the “notification of final group communication end” is transmitted to the time measurement terminal. When the time measurement terminal receives the notification of final group communication end, it stores “1” in the final group communication end flag (details to be explained later).

If the final group communication end flag is not “1” (no at step S16), the process operates on stand-by until the final group communication end flag becomes “1”. On the other hand, if the final group communication end flag is “1” (yes at step S16), this means that the elapsing of the certain period of time has been measured by the timer and that the communication is complete up to the final group, and the process is therefore performed in order to cause the time measurement terminal to function as the leader terminal 1. In other words, “0” is set as the “go_round” variable, the control flag (control_flg) is switched “ON” and the ID of the first communication group on the communication group list is set as the ID of the current communication group that is targeted for communication from now (step S18). Then, to perform control over the fixed cycle, the timer process is once more activated (step S19).

It is next determined whether “1” is stored in the control flag storage area 31, namely whether the control flag (control_flg) is switched “ON” (step S20).

When the control flag is switched “ON” (yes at step S20), the leader terminal process is performed (step S30). When the control flag is switched “OFF” (no at step S20), the member terminal process is performed (step S50). The leader terminal process will be explained later. As the member terminal process is the same as for the first embodiment, an explanation is omitted here.

When the leader terminal process or the member terminal process ends, it is determined whether the communication terminal power source is switched “OFF” (step S70). If the power source is switched “OFF” (yes at step S70), all the processes are ended. On the other hand, if the power source is not switched “OFF” (no at step S70), the process returns to step S13 and the process is repeated.

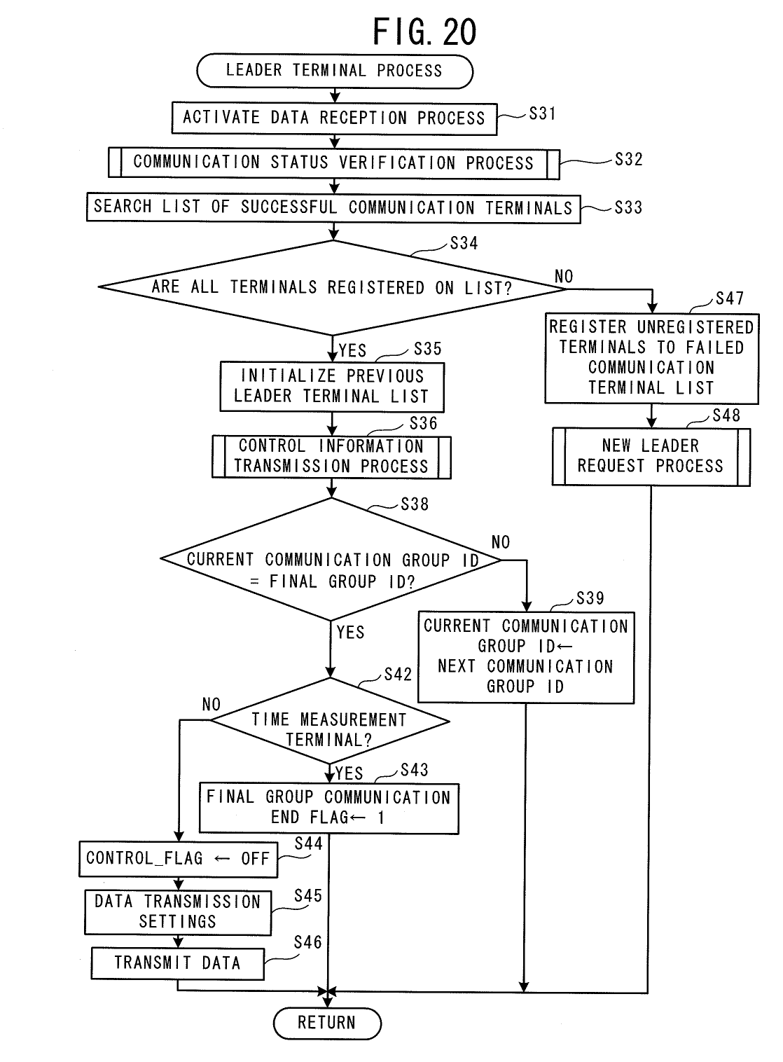

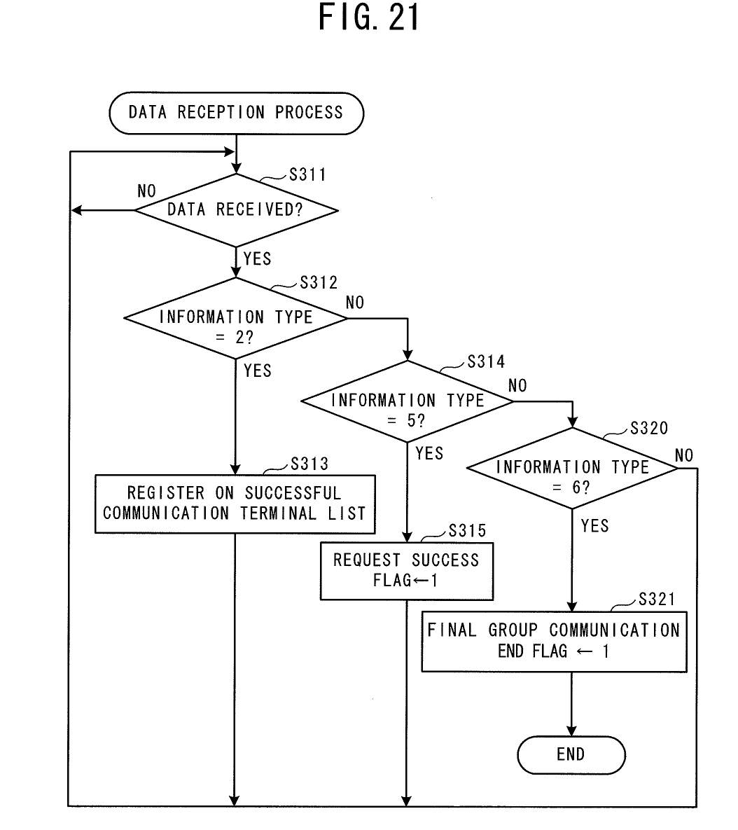

The leader terminal process will be explained with reference to FIG. 20 and FIG. 21. As shown in FIG. 20, when the leader terminal process is started, first the data reception process is activated (step S31). In the data reception process, the data is received from the other terminals, and different processes are performed according to each of the information types of the received data.

The data reception process will be explained with reference to FIG. 21. When the data reception process is activated, it is first determined whether the data has been received (step S311). If the data has not been received (no at step S311), the leader terminal 1 operates on stand-by until it receives the data. If the data has been received (yes at step S311), next, the information type of the received data is determined in order (step S312, step S314 and step S320), and the process is performed in accordance with the information type.

First, it is determined whether the received information type is “2” (step S312). The information type “2” is the “notification of reception of communication verification status” that is transmitted by the member terminal when the information type “1” data transmission is received. If the information type is “2” (yes at step S312), it is understood that the member terminal 2 that transmitted the data (the transmission source member terminal 2) and the current leader terminal 1 are in a state in which communication is possible. As a consequence, the terminal ID of the transmission source member terminal 2 is retrieved from the received data, registered on the successful communication terminal list on the leader terminal 1, and stored in the successful communication terminal storage area 32 (step S313). Then, the process returns to step S311 and waits to receive the data. The successful communication terminal list is initialized by the communication status verification process, to be explained later. Then, each time the data reception process performed in parallel performs step S313, the terminal for which the communication is successful is added to the successful communication terminal list.

If the information type of the data received by the leader terminal 1 is not “2” (no at step S312), it is next determined whether the received data information type is “5” (step S314). The information type “5” is the “notification of new leader request” transmitted by the member terminal when it receives the information type “4” data transmission. If the received data information type is “5” (yes at step S314), it is understood that the terminal that transmitted the data is able to become the new leader terminal and “1” is stored in the leader terminal 1 successful request flag (step S315). The successful request flag is referred to during the new leader request process (see FIG. 20, step S48). Then, the process returns to step S311 and waits to receive data.

If the information type of the data received by the leader terminal 1 is not “5” (no at step S314), it is next determined whether the received data information type is “6” (step S320). The information type “6” is the “notification of final group communication end” from the leader terminal 1 to the time measurement terminal that indicates that the transmission of the control information has been completed up to the final group. If the received data information type is “6” (yes at step S320), the final group communication end flag of the current leader terminal 1 is set to “1” (S321) and the data reception process is ended. If the received data information type is not “6” (no at step S320), the process returns to step s311 and waits to receive data. As explained above, the final group communication end flag is referred to in the main process (see FIG. 19, step S16).

In the above way, once the data reception process is activated, the above process is repeatedly performed. As explained above, the results of performing the above process are referred to at various points in the other processes.

When the process returns to the leader terminal process (see FIG. 20), after the data reception process is activated (step S31), next the communication status verification process is performed, in which it is checked group by group whether communication is possible with each of the member terminals 2 (step S32). The details of the communication status verification process are the same as for the second embodiment and an explanation is therefore omitted here.

Next the successful communication terminal list that is stored in the successful communication terminal storage area 32 is searched (step S33). The ID of the terminals from which data has been received with the information type “2” as part of the data reception process (see FIG. 21) during the certain stand-by period during the communication status verification process, namely the ID of the terminals that are able to communicate with the leader terminal 1 are listed on the successful communication terminal list that is searched. The terminals with which communication is possible are matched against the all terminal list that is stored in the all terminal storage area 34. It is then determined whether all the member terminals in the current communication group, which is the group targeted for communication, are registered on the successful communication terminal list (step S34).

If all of the member terminals in the current communication group are registered on the successful communication terminal list (yes at step S34), this means that for the current communication group the current leader terminal 1 does not have any cases of failed communication. Accordingly, the previous leader terminal list is initialized (step S35). Then, the process is performed to transmit the control information to the current communication group (the control information transmission process) (step S36). The details of the control information transmission process are the same as explained for the first embodiment with reference to FIG. 8, and an explanation is therefore omitted here.

It is next determined whether the ID of the current communication group is the ID of the final group on the communication group list stored in the communication group storage area 33 (step S38). If the current communication group is not the final group (no at step S38), the process sets the ID of the next group as the current communication group ID (step S39), and returns to the main process (see FIG. 19).

On the other hand, if the current communication group is the final group (yes at step S38), it is next determined whether the communication terminal is the time measurement terminal (step S42). When the communication terminal is the time measurement terminal (yes at step S42), as the communication is complete up to the final group, “1” is stored in the final group communication end flag (step S43) and the process returns to the main process.

When the communication terminal is not the time measurement terminal (no at step S42), as the communication is complete up to the final group, from the next time, the current leader terminal 1 ceases to be the leader terminal 1 and the control flag is switched “OFF” (step S44). Then, transmission data settings are made (step S45) in order to transmit notification to the time measurement terminal to indicate that the series of communications has been completed up to the final group. In other words, the time measurement terminal ID is set as the transmission destination and the information type is set as “6”. The information type “6” is the “notification of final group communication end” that indicates that the transmission of the control information from the leader terminal 1 has been completed up to the final group. Then, the set data is transmitted (step S46) and the process returns to the main process.

Meanwhile, if as a result of searching the successful communication terminal list, one of the terminals in the current communication group is not registered on the successful communication terminal list (no at step S34), the terminal that is not on the successful communication terminal list is registered on the failed communication terminal list and is stored in the failed communication terminal storage area 37 (step S47). Then, as a case of failed communication has occurred with the current leader terminal 1, the new leader request process is performed to request the new leader terminal (step S48). After that, the process returns to the main process (see FIG. 19). Note that details of the new leader request process are the same as for the second embodiment, and an explanation is therefore omitted here.

As explained above, in the wireless communication system 100 according to the third embodiment, a specific one of the communication terminals functions constantly as the time measurement terminal, and, each time the certain period of time elapses, the time measurement terminal becomes the leader terminal 1. However, when one of the terminals other than the time measurement terminal is the leader terminal 1, the time measurement terminal is always notified when the transmission of the control information for each group is completed up to the final group. As a consequence, the time measurement terminal is reinstated as the leader terminal 1 when both the certain period of time has elapsed and the transmission of the control information to all the groups has been completed. In this way, the highest priority is accorded to the completion of the control with regard to all the groups, and after the process has been performed smoothly for all of the groups based on the control information within the certain period of time, the present disclosure can be effectively utilized while synchronous communication is periodically performed group by group over a fixed time interval.

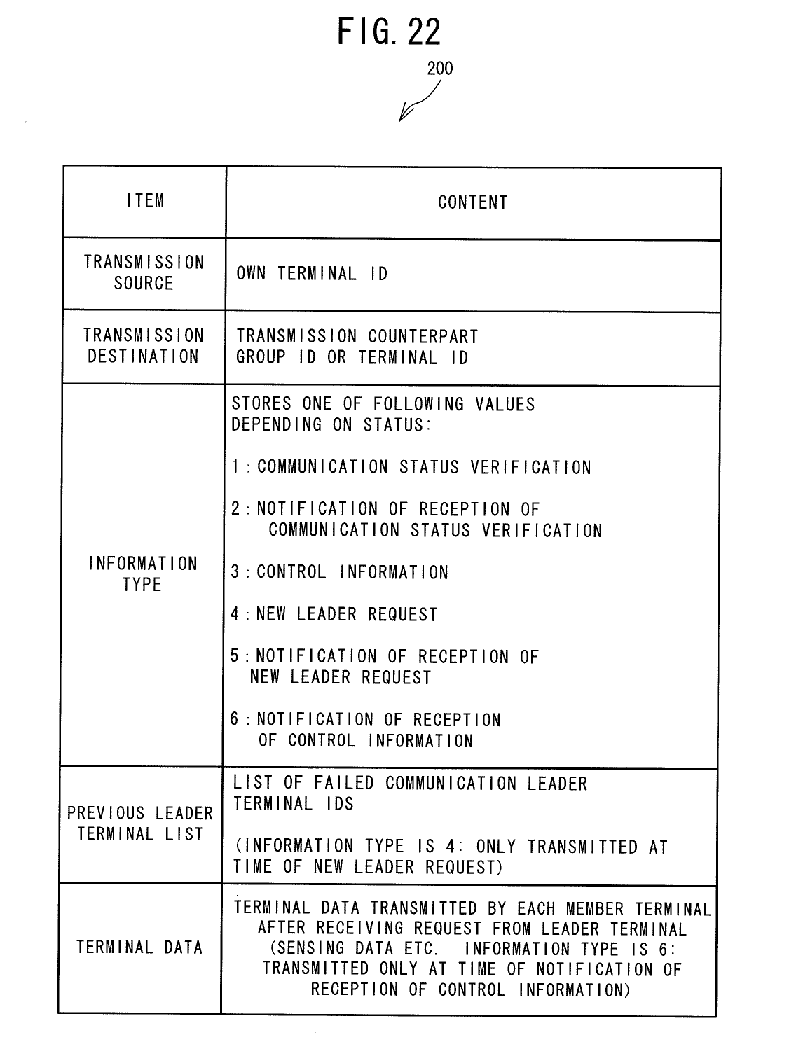

Next, a fourth embodiment will be explained with reference to FIG. 22 to FIG. 25. In the fourth embodiment, data is collected from the member terminals 2 for each of the groups 3 in turn, the collected data is transmitted from the leader terminal 1 to a server and the collected data is accumulated in the server.

In the wireless communication system 100 according to the fourth embodiment, the transceived data 200 is transmitted and received as shown in FIG. 22. As shown in FIG. 22, the transceived data 200 includes five information items, namely the transmission source information, the transmission destination information, the information type, the previous leader terminal list and terminal data. The ID of the terminal transmitting the data is set in the transmission source information. The group ID or the terminal ID of the transmission counterpart terminal is set in the transmission destination information. As broadcast transmission is performed in the wireless communication system 100, the transmission counterpart ID is essential. When the ID set in the transmission destination information of the received data matches the terminal's own ID, or matches the ID of the group to which the terminal itself belongs, each of the terminals determines that the data is targeted to itself. One of values from 1 to 6 is set in the information type. Each of the values is allocated to the following type of functions. 1: Communication status verification; 2: Notification of reception of communication status verification; 3: Control information; 4: New leader request; 5: Notification of reception of new leader request; 6: Notification of reception of control information. When the information type is “4”, the previous leader terminal list, that is the list of the terminals that were previously the leader terminal 1, is attached. Further, when the information type is “6”, data in accordance with the control information is transmitted from the member terminal 2.

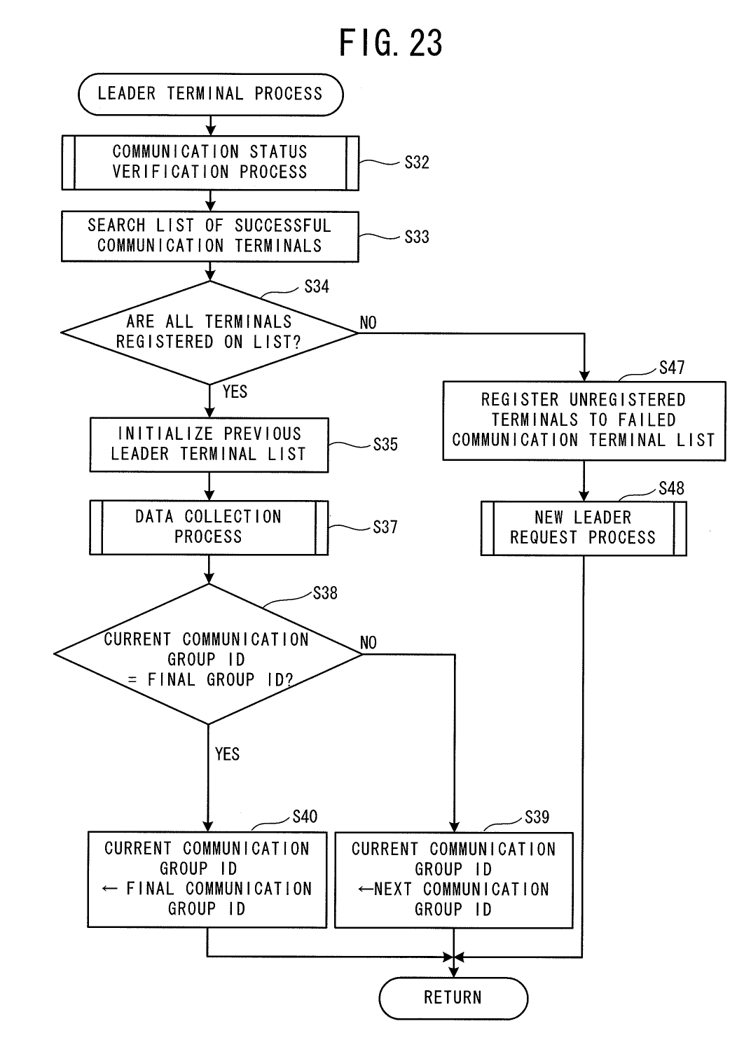

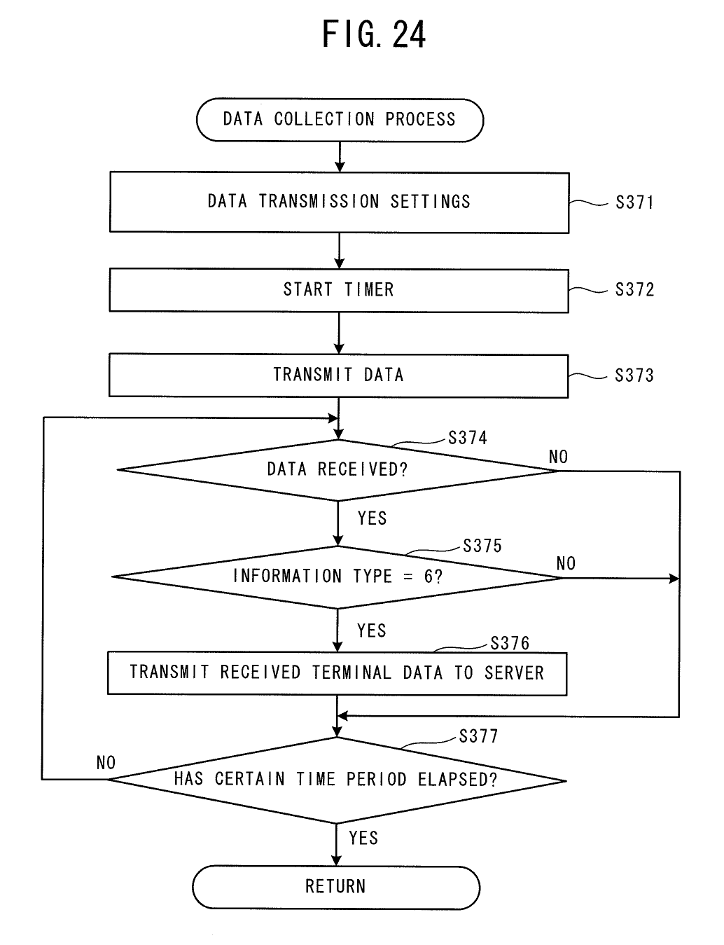

In the fourth embodiment, the communication terminal repeatedly performs the same main process (see FIG. 5) as in the first embodiment from when the power source is switched “ON” to when the power source is switched “OFF”. A detailed explanation is omitted here. Next, the leader terminal process that is performed during the main process will be explained with reference to FIG. 23 and FIG. 24.

As shown in FIG. 23, when the leader terminal process is started, first the leader terminal 1 performs the communication status verification process group by group to check whether it is able to communicate with each of the member terminals 2 (step S32). The details of the communication status verification process are the same as for the first embodiment (see FIG. 7) and an explanation is therefore omitted here.

Next, the successful communication terminal list that is stored in the successful communication terminal storage area 32 is searched (step S33). Only the terminals from which the response was returned in the communication status verification process are listed on the successful communication terminal list. The list of the terminals from which the response has been received is matched against the all terminal list that is stored in the all terminal storage area 34. It is then determined whether all the member terminals 2 in the current communication group, which is the group currently targeted for communication, are registered on the successful communication terminal list (step S34).

If all of the member terminals in the current communication group are registered on the successful communication terminal list (yes at step S34), this means that for the current communication group the current leader terminal 1 does not have any cases of failed communication. Accordingly, the previous leader terminal list is initialized (step S35). Then, a data collection process is performed to collect data from the member terminals of the current communication group (step S37). Details of the data collection process will be explained later with reference to FIG. 24.

It is next determined whether the ID of the current communication group is the ID of the final group on the communication group list stored in the communication group storage area 33 (step S38). If the current communication group is not the final group (no at step S38), in order to collect the data from the next group, the process sets the ID of the next group as the current communication group ID (step S39), and returns to the main process. On the other hand, if the current communication group is the final group (yes at step S38), in order to return to the first group and collect the data, the process sets the first group ID as the current communication group (step S40) and returns to the main process.

Meanwhile, if as a result of searching the successful communication terminal list, one of the terminals in the current communication group is not registered on the successful communication terminal list (no at step S34), the terminal that is not on the successful communication terminal list is registered on the failed communication terminal list and is stored in the failed communication terminal storage area 37 (step S47). Then, as a case of failed communication has occurred with the current leader terminal 1, the new leader request process is performed to request the new leader terminal (step S48). After that, the process returns to the main process. Note that details of the new leader request process are the same as for the first embodiment (see FIG. 9), and an explanation is therefore omitted here.

The data collection process that is performed during the leader terminal process will be explained in detail with reference to FIG. 24. When the data collection process is started, first, transmission data settings are made (step S371). As described above, in the fourth embodiment, the transceived data 200 has the type of configuration shown in FIG. 22, and therefore the ID of the group that is targeted for communication from now (the current communication group) is set as the transmission destination and “3” is set as the information type. The “3” set as the information type is the “control information” that causes the member terminal 2 to perform the particular process. In the fourth embodiment, the process required by the information type “3” is the collection of data from the member terminal 2. The data to be collected is, for example, sensing data from the variety of sensors 40 provided on the member terminal 2 and the like.

When the transmission data settings are complete, the timer process is started to measure the response time from the member terminal 2 (step S372), and the set transmission data is transmitted (step S373). Next, it is determined whether the current leader terminal 1 has received the response data from the member terminal 2 (step S374). When the current leader terminal 1 has received the response data (yes at step S374), it is determined whether the information type of the received data is “6” (step S375). The information type “6” is the “notification of reception of control information” transmitted by the member terminal when it has received the information type “3” data transmission. In this type of communication, as illustrated in FIG. 22, the terminal data is attached. Here, if the information type is “6” (yes at step S375), the received terminal data is transmitted to the external server (not shown in the figures) (step S376).

If the current leader terminal 1 has not received the response data from the member terminal 2 (no at step S374), or if the received data information type is not “6” (no at step S375), the process advances to step S377 and it is determined whether the certain period of time has elapsed since the data transmission. If the certain period of time has not elapsed since the data transmission (no at step S377), the process returns to step S374, waits to receive the data and repeats the determination of the information type. If the certain period of time has elapsed since the data transmission (yes at step S377), the process returns to the leader terminal process.

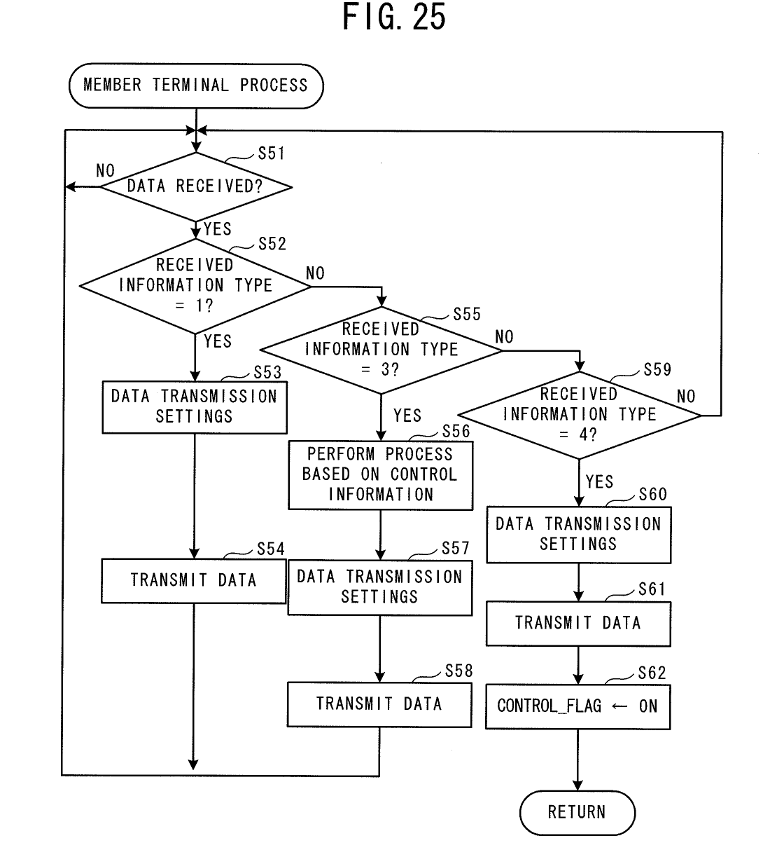

The member terminal process will be explained with reference to FIG. 25. The member terminal process is performed in the main process when the control flag of the terminal is switched “OFF” (no at step S20).

When the member terminal process is started, it is first determined whether the communication terminal has received the data (step S51). If the communication terminal has not received the data (no at step S51), it operates on stand-by until it receives the data.

If the communication terminal has received the data (yes at step S51), next, the information type of the received data is determined in order (step S52, step S55 and step S59), and the process is performed in accordance with the type.

First, it is determined whether the information type of the received data is “1” (step S52). If the information type of the received data is “1” (yes at step S52), as that is the “communication status verification” from the leader terminal 1, data settings are made in order to transmit the message in response to the communication status verification (step S53). In other words, the transmission source terminal ID of the received data is set as the transmission destination for the transmission data, and the information type is set as “2”. The information type “2” is the “notification of reception of communication status verification”. Then, the set data is transmitted (step S54), and the process returns to step S51 and waits to receive data.

If the information type of the received data is not “1” (no at step S52), it is next determined whether the information type of the received data is “3” (step S55). If the received information type is “3” (yes at step S55), that is the instruction from the leader terminal 1, and therefore the process that is established in advance, or the data collection process that is based on the command transmitted with the control information, is performed (step S56). Then, in order to transmit the collected data to the leader terminal 1, data settings are made (step S57). In other words, the transmitted data transmission source terminal ID is set as the transmission destination, the information type is set as “6”, and the terminal data is set. The information type “6” is the “notification of reception of control information”. Then, the set data is transmitted (step S58) and the process returns to step S51 and waits to receive data.

If the information type of the received data is not “3” (no at step S55), it is next determined whether the received information type is “4” (step S59). If the received information type is “4” (yes at step S59), that is the “new leader request” from the current leader terminal 1 and transmission data settings are therefore made (step S60) in order to transmit the acceptance message in response to the new leader request. In other words, the received data transmission source terminal ID is set as the transmission destination for the transmission data, and the information type is set as “5”. The information type “5” is the “notification of reception of new leader request”. Then, the set data is transmitted (step S61), and the control flag is switched “ON” (step S62). The process then returns to the main process. As the control flag is switched “ON”, for the next time of processing in the main process, the communication terminal performs the leader terminal process (FIG. 5, yes at step S20; step S30).

If the received data information type is not “4” (no at step S59), the process returns as it is to step S51 and waits to receive data.

As explained above, in the wireless communication system 100 according to the fourth embodiment, the control information transmitted group by group from the leader terminal 1 requests the transmission of a variety of data collected from the member terminals. Then, when each of the member terminals receives the control information, it transmits the terminal data, such as, for example, the sensing data detected by the variety of sensors. When the leader terminal 1 receives the terminal data, it transmits the terminal data to the external server and causes the data to be accumulated there. In the fourth embodiment also, the leader terminal 1 is replaced depending on the communication status, and here, because the leader terminal 1 that has received the terminal data transmits the terminal data to the external server, it is not necessary to transmit the terminal data to the new leader terminal 4 when the leader terminal is replaced. Note that the data collection process in the fourth embodiment can be used in combination with the control performed over the fixed cycle using the time measurement terminal, as described in the second and third embodiments.

As explained above, in the wireless communication system according to the present disclosure, when the control terminal does not receive the response information from one of the controlled terminals belonging to one of the groups within the prescribed period of time, the control terminal selects, from among the controlled terminals, one of the controlled terminals to become the new control terminal in place of the original control terminal itself, and transmits the request information to the selected controlled terminal to request the selected controlled terminal to become the control terminal. If the selected controlled terminal transmits the acceptance information in response to the request information, the control terminal transfers to become the controlled terminal, and the controlled terminal that transmitted the acceptance information becomes the control terminal. Accordingly, when communication with one of the controlled terminals in one of the groups becomes impossible due to an environmental cause, such as the presence of an obstacle or shield, the suitable terminal can be selected from among the controlled terminals to become the next control terminal. For that reason, it is possible to flexibly deal with communication failure in comparison to a case in which the control terminal is replaced using a fixed order of priority established in advance.

Further, in the wireless communication system according to the present disclosure, candidate controlled terminals that are able to become the next control terminal may be prepared, and the next control terminal may be selected from among the candidates. If this is done, the next control terminal can be selected from among the preferable controlled terminals. For that reason, the selection of the next control terminal and the acceptance process can be efficiently performed, thus raising the probability of success of the next communication.

Moreover, in the wireless communication system according to the present disclosure, the failed delivery list may be prepared, that is the list of the controlled terminals from which the response information is not transmitted. In this case, the candidates for the next control terminal are prepared from among the controlled terminals that are not on the failed delivery list. Accordingly, the controlled terminal with which there has previously been communication failure is not selected as the next control terminal. For that reason, the selection of the next control terminal and the acceptance process can be efficiently performed, thus raising the probability of success of the next communication.

Further, in the wireless communication system according to the present disclosure, one of a plurality of the controlled terminals may be established as a time measurement terminal that measures time, and that transmits transition instruction information to the control terminal after a prescribed period of time has elapsed. In this case, through the transmission of the transition instruction information, the control terminal transfers to become the controlled terminal and the time measurement terminal becomes the new control terminal. Accordingly, the control terminal is forcibly replaced after the certain period of time, and effective control can be achieved when the control is repeatedly being performed over a fixed time cycle.

Also, in the wireless communication system according to the present disclosure, one of the plurality of the controlled terminals may be established as the time measurement terminal that measures time, and, in a case when the control terminal is not the time measurement terminal, when the response information has been received from all the groups, the control terminal may transmit the notification of final group communication end to the time measurement terminal, and, at the same time, transfer to become the controlled terminal. In this case, the time measurement terminal measures time, and when the prescribed period of time has elapsed and the time measurement terminal has also received the notification of final group communication end, the time measurement terminal transfers to become the control terminal. Accordingly, while giving the highest priority to the completion of the control with regard to all the groups, effective control can be achieved when the control is repeatedly being performed over a fixed time cycle.

Moreover, in the wireless communication system according to the present disclosure, the controlled terminal information collected by the control terminal may be transmitted to the external server. In this way, when the control terminal transfers to become another of the terminals, it is not necessary to perform the process to transmit the controlled terminal information collected by the control terminal to the transfer destination terminal and so on. Accordingly, even if the number of controlled terminals increases and the volume of information increases, the information collection control can be performed regardless of the memory capacity of the control terminal.

The communication terminal according to the present disclosure functions as one of either the control terminal and the controlled terminal. When the communication terminal is the control terminal, if it does not receive the response information from the controlled terminal belonging to one of the groups within the prescribed period of time, the control terminal selects, from among the controlled terminals, one of the controlled terminals to become the new control terminal in place of the original control terminal itself, and transmits the request information to the selected controlled terminal to request the selected controlled terminal to become the control terminal. If the selected controlled terminal transmits the acceptance information in response to the request information, the control terminal transfers to become the controlled terminal. When the communication terminal is the controlled terminal, it always operates in accordance with the control information transmitted from the control terminal, and when it receives the request information from the control terminal, it transmits the acceptance information and becomes the control terminal. Therefore, when communication with one of the controlled terminals in one of the groups is impossible due to an environmental reason, such as the presence of an obstacle or shield, the suitable terminal can be selected from among the controlled terminals and can become the control terminal. For that reason, it is possible to flexibly deal with communication failure in comparison with a case in which the control terminal is replaced using a fixed order of priority established in advance.

Further, when the communication terminal according to the present disclosure is the control terminal, it may prepare candidates from the controlled terminals that are able to become the next control terminal and may select the next control terminal from among the candidates. Accordingly, the next control terminal can be selected from among the preferable controlled terminals. For that reason, the selection of the next control terminal and the acceptance process can be efficiently performed, thus raising the probability of success of the next communication.

Moreover, when the communication terminal according to the present disclosure is the control terminal, it may prepare the failed delivery list, that is the list of the controlled terminals from which the response information was not transmitted. In this case, the candidates for the next control terminal are prepared from among the controlled terminals that are not on the failed delivery list. Accordingly, the controlled terminal with which there has previously been communication failure is not selected as the next control terminal. For that reason, the selection of the next control terminal and the acceptance process can be efficiently performed, thus raising the probability of success of the next communication.

According to the present disclosure, when the communication terminal functions as the time measurement terminal, in addition to being the controlled terminal, the communication terminal may measure time, and transmit the transition instruction information to the control terminal after the prescribed period of time has elapsed. After that, the time measurement terminal itself may become the control terminal. In this case, the time measurement terminal that is the controlled terminal forcibly becomes the control terminal after a fixed period of time, and therefore effective control can be achieved when the control is being repeatedly performed over a fixed time cycle.

Also, according to the present disclosure, when the communication terminal functions as the time measurement terminal, in addition to being the controlled terminal, the communication terminal may measure time, and transfer to become the control terminal when both the certain period of time has elapsed and the notification has been received from the control terminal indicating completion of the reception of the response information from all of the groups. In this case, while giving the highest priority to the completion of the control with regard to all the groups, effective control can be achieved when the control is being repeatedly performed over a fixed time cycle.

Moreover, when the communication terminal according to the present disclosure functions as the control terminal, the data collected from the controlled terminal may be transmitted to the external server. In this case, when the control terminal transfers to become another of the terminals, it is not necessary to perform the process to transmit the controlled terminal information collected by the control terminal to the transfer destination terminal and so on. Accordingly, even if the number of controlled terminals increases and the volume of information increases, the information collection control can be performed regardless of the memory capacity of the control terminal.

While the invention has been described in connection with exemplary embodiments, it will be understood by those skilled in the art that other variations and modifications of the exemplary embodiments described above may be made without departing from the scope of the invention. Other embodiments will be apparent to those skilled in the art from a consideration of the specification or practice of the invention disclosed herein. It is intended that the specification and the described examples are considered merely as exemplary of the invention, with the true scope of the invention being indicated by the following claims.

What is claimed is:

1. A wireless communication system that is connected via a wireless network to a control terminal and a controlled terminal, wherein the control terminal and the controlled terminal belong to one or more groups and the control terminal performs transmission to each of the groups, the control terminal that transmits control information comprising:
a control information transmitter that transmits the control information to a plurality of the controlled terminals;
a response information receptor that receives response information from the controlled terminal;
a selector that selects the controlled terminal from among the controlled terminals to become a new control terminal to replace the current control terminal when the response information receptor has not received the response information from one of the controlled terminals belonging to one of the groups within a prescribed period of time;
a request information transmitter that transmits request information to the controlled terminal selected by the selector to request the selected controlled terminal to become the control terminal; and
a controlled terminal transition device that stops the control terminal being the control terminal and transfers it to become the controlled terminal when acceptance information has been received from the controlled terminal indicating acceptance to become the control terminal; and
the controlled terminal that operates based on the control information transmitted from the control terminal comprising:
a control information receptor that receives the control information from the control terminal;
a response information transmitter that transmits the response information to the control terminal when the control information is received by the control information receptor;
an operation execution device that performs an operation prescribed by the control information received by the control information receptor;
a request information receptor that receives the request information from the control terminal;
an acceptance information transmitter that transmits the acceptance information to the control terminal when the request information is received by the request information receptor; and
a control terminal transition device that, when the acceptance information is transmitted by the acceptance information transmitter, stops the controlled terminal being the controlled terminal and transfers it to become the control terminal.

2. The wireless communication system according to claim 1, wherein
the control terminal further comprises:
a candidate preparation device that prepares candidates that are the controlled terminals that are able to become the new control terminal; and wherein
the selector selects the controlled terminal to become the new control terminal from among the candidates prepared by the candidate preparation device.

3. The wireless communication system according to claim 2, wherein
the control terminal further comprises:
a failed delivery list preparation device that prepares a failed delivery list that is the list of the controlled terminals from which the response information receptor did not receive the response information within the prescribed period of time; and wherein
the candidate preparation device prepares as the candidates the controlled terminals that are not listed on the failed delivery list by the failed delivery list preparation device.

4. The wireless communication system according to claim 1, wherein one of the plurality of controlled terminals is a time measurement terminal that measures time, the time measurement terminal comprising:
a time measurement device that measures elapsing of a period of time;
an elapsed time determination device that determines whether a certain period of time measured by the time measurement device has elapsed; and
a transition instruction information transmitter that, when it is determined by the elapsed time determination portion that the certain period of time has elapsed, transmits transition instruction information that instructs the control terminal to stop being the control terminal and instructs the control terminal to become the controlled terminal; wherein
the control terminal transition device operates when the transition instruction information is transmitted by the transition instruction information transmitter, and
in the control terminal,
the controlled terminal transition device operates when the transition instruction information is received from the time measurement terminal.

5. The wireless communication system according to claim 1 wherein one of the plurality of controlled terminals is a time measurement terminal that measures time, wherein
the control terminal comprises:
a reception determination device that determines whether the response information has been received from all the controlled terminals of all the groups; and
a final group communication end notification information transmitter that, when the reception determination device determines that the response information has been received from all the controlled terminals of all the groups, transmits a final group communication end notification to the time measurement terminal showing that the response information has been received from all the controlled terminals of all the groups; wherein
the controlled terminal transition device operates when the reception determination device determines that the response information has been received from all the controlled terminals of all the groups, and
the time measurement terminal comprises:
a time measurement device that measures elapsing of a period of time;
an elapsed time determination device that determines whether a certain period of time measured by the time measurement device has elapsed; and
a final group communication end notification information receptor that receives the final group communication end notification information; wherein
the control terminal transition device operates when it is determined by the elapsed time determination device that the certain period of time has elapsed and the final group communication end notification information has also been received by the final group communication end notification information receptor.

6. The wireless communication system according to claim 1, wherein
in the controlled terminal,
the operation execution device transmits prescribed information to the control terminal based on the control information, and
the control terminal further comprises:
a collected information transmitter that transmits the prescribed information received from the controlled terminal to a server to which it is connected via a network.

7. A communication terminal that is mutually connected to other communication terminals via a network, wherein
when the communication terminal functions as a control terminal that transmits control information, the communication terminal comprises:
a control information transmitter that transmits the control information to a controlled terminal;
a response information receptor that receives response information from the controlled terminal;
a selector that selects the controlled terminal from among the controlled terminals to become a new control terminal to replace the current control terminal when the response information receptor has not received the response information from one of the controlled terminals belonging to a group within a prescribed period of time;
a request information transmitter that transmits request information to the controlled terminal selected by the selector to request the selected controlled terminal to become the control terminal; and
a controlled terminal transition device that stops the control terminal being the control terminal and transfers it to become the controlled terminal when acceptance information has been received from the controlled terminal indicating acceptance to become the control terminal; and wherein
when the communication terminal functions as the controlled terminal that operates based on the control information transmitted from the control terminal, the communication terminal comprises:
a control information receptor that receives the control information from the control terminal;
a response information transmitter that transmits the response information to the control terminal when the control information is received by the control information receptor;
an operation execution device that performs an operation prescribed by the control information received by the control information receptor;
a request information receptor that receives the request information from the control terminal;
an acceptance information transmitter that transmits the acceptance information to the control terminal when the request information is received by the request information receptor; and
a control terminal transition device that, when the acceptance information is transmitted by the acceptance information transmitter, stops the controlled terminal being the controlled terminal and transfers it to become the control terminal.

8. The communication terminal according to claim 7, wherein
when the communication terminal functions as the control terminal, the communication terminal further comprises:
a candidate preparation device that prepares candidates that are the controlled terminals that are able to become the new control terminal; and wherein
the selector selects the controlled terminal to become the new control terminal from among the candidates prepared by the candidate preparation device.

9. The communication terminal according to claim 8, wherein
when the communication terminal functions as the control terminal, the communication terminal further comprises:
a failed delivery list preparation device that prepares a failed delivery list that is the list of controlled terminals from which the response information receptor did not receive response information within a prescribed period of time; and wherein
the candidate preparation device prepares as the candidates, the controlled terminals that are not listed on the failed delivery list by the failed delivery list preparation device.

10. The communication terminal according to claim 7, wherein the communication terminal functions as the controlled terminal and also functions as a time measurement terminal that measures time, and
when the communication terminal functions as the time measurement terminal, the communication terminal comprises:
a time measurement device that measures elapsing of a period of time;
an elapsed time determination device that determines whether a certain period of time measured by the time measurement device has elapsed; and
a transition instruction information transmitter that, when it is determined by the elapsed time determination portion that the certain period of time has elapsed, transmits transition instruction information that instructs the control terminal to stop being the control terminal and to become the controlled terminal; and wherein
the control terminal transition device operates when the transition instruction information is transmitted by the transition instruction information transmitter.

11. The communication terminal according to claim 7, wherein the communication terminal functions as the controlled terminal and also functions as a time measurement terminal that measures time, and
when the communication terminal functions as the time measurement terminal, the communication terminal comprises:
a time measurement device that measures elapsing of a period of time;
an elapsed time determination device that determines whether a certain period of time measured by the time measurement device has elapsed; and
a final group communication end notification information receptor that receives final group communication end notification information from the control terminal that indicates that the response information has been received from all the controlled terminals in all the groups; and wherein
the control terminal transition device operates when it is determined by the elapsed time determination device that the certain period of time has elapsed and the final group communication end notification information has also been received by the final group communication end notification information receptor.

12. The communication terminal according to claim 7, wherein
when the communication terminal functions as the controlled terminal,
the operation execution device transmits prescribed information to the control terminal based on the control information, and
when the communication terminal functions as the control terminal,
the control terminal further comprises:
a collected information transmitter that transmits the prescribed information received from the controlled terminal to a server to which it is connected via a network.

13. A computer-readable storage medium storing a wireless communication program that causes a computer to function to perform the variety of processes of the communication terminal described in claim 7.
